(19) United States
(12) Patent Application Publication
(10) Pub. No.: US 2025/0209481 A1
(43) Pub. Date: Jun. 26, 2025

(54) SYSTEMS AND METHODS FOR MACHINE LEARNING-BASED GENERATION OF INTERACTIVE VIRTUAL PERSONA COMMUNITIES

(71) Applicant: Socialtrait Inc., Mount Waverley (AU)

(72) Inventors: Lukas Judith, Sydney (AU); Suraj Narayanan Sasikumar, Sydney (AU)

(73) Assignee: Socialtrait Inc., Mount Waverley (AU)

(21) Appl. No.: 18/989,725

(22) Filed: Dec. 20, 2024

Related U.S. Application Data
(60) Provisional application No. 63/736,746, filed on Dec. 20, 2024.
(60) Provisional application No. 63/613,860, filed on Dec. 22, 2023.

(51) Int. Cl. G06Q 30/0203; G06F 40/40; G06V 20/40

(52) U.S. Cl. CPC G06Q 30/0203; G06F 40/40; G06V 20/46; G06V 20/49

(57) ABSTRACT

A computer-implemented system, computer-implemented method, and computer-program product includes at a virtual persona service: identifying a respective set of permitted values or a respective distribution of values for each community persona variable of a set of community persona variables; constructing a virtual community persona template; generating a virtual community based on the virtual community persona template; receiving a user query and an indication of a virtual persona of the virtual persona community via an interactive user interface; constructing a persona-describing prompt based on a distinct set of community variables and associated variable values corresponding to the indicated virtual persona; providing, to one or more language learning models, the user query and the persona-describing prompt; and outputting, from the one or more language learning models, a response to the user query via the interactive user interface.

### CROSS-REFERENCE TO RELATED APPLICATIONS

This application claims the benefit of U.S. Provisional Application No. 63/736,746 filed on 20 Dec. 2024 and U.S. Provisional Application No. 63/613,860, filed on 22 Dec. 2023, which are incorporated in their entireties by this reference.

### TECHNICAL FIELD

The inventions herein relate generally to the machine learning-based data research and analysis fields, and more specifically to a new and useful system and method for generating virtual persona communities using machine learning in the machine learning-based data research and analysis field.

### BACKGROUND

Contemporary socioeconomic and market analysis and research technologies employ various methodologies for collecting and sourcing data from populations to gain insights into individual behavior and preferences. These approaches frequently involve techniques such as focus groups, surveys, individual observation, and other methods that are often time-consuming and costly. Furthermore, it is often difficult to capture the vast diversity of individual experiences and perspectives, limiting the development of accurate and nuanced understandings of individual behavior in multifaceted communities.

Therefore, there is a need in the machine learning-based data research and analysis field to create improved systems and methods for implementing machine learning-based generation of interactive virtual persona communities. The embodiments of the present application described herein provide technical solutions that address, at least, the needs described above, as well as deficiencies of the state of the art.

### BRIEF SUMMARY OF THE EMBODIMENT(S)

This summary is not intended to identify only key or essential features of the described subject matter, nor is it intended to be used in isolation to determine the scope of the described subject matter. The subject matter should be understood by reference to appropriate portions of the entire specification of this patent, any or all drawings, and each claim.

In some embodiments, a computer-implemented method may comprise at a virtual persona service: identifying, by one or more processors, a respective set of permitted values or a respective distribution of values for each community persona variable of a set of community persona variables; constructing, by the one or more processors, a virtual community persona template that indicates the respective set of permitted values or the respective distribution of values for each community persona variable of the set of community persona variables; generating, by the one or more processors, a virtual persona community based at least in part on the virtual community persona template, wherein the generating comprises: providing, by the one or more processors, the virtual community persona template and a set of persona-generating prompts to one or more language models, wherein each persona-generating prompt of the set of persona-generating prompts comprises a set of instructions informing the one or more language learning models to select variable values for a respective subset of the set of community persona variables; obtaining, by the one or more processors, one or more batches of virtual personas from the one or more language learning models based at least in part on the provided virtual community persona template and the set of persona-generating prompts, wherein each batch of the one or more batches comprises a plurality of distinct sets of community persona variables and associated variable values, each distinct set of the plurality of distinct sets mapping to a respective virtual persona; aggregating, by the one or more processors, the one or more batches of virtual personas to form the virtual persona community; receiving, by the one or more processors, a user query and an indication of a virtual persona of the virtual persona community via an interactive user interface; constructing, by the one or more processors, a persona-describing prompt based at least in part on the respective distinct set of community variables and associated variable values corresponding to the indicated virtual persona; providing, by the one or more processors and to the one or more language learning models, the user query and the persona-describing prompt; and outputting, by the one or more processors and from the one or more language learning models, a response to the user query via the interactive user interface based at least in part on the provided user query and the persona-describing prompt.

In some embodiments, the computer-implemented method may further comprise: at the virtual persona service: applying, by the one or more processors and for each virtual persona generated by the one or more language learning models for a batch of the one or more batches, a variable value consistency assessment to identify a subset of the virtual personas that each have one or more community persona variables associated with an attribute inconsistency, a logical contradiction, or a statistical anomaly; and updating, by the one or more processors, each virtual persona of the subset of the virtual personas, wherein the updating comprises generating updated values for the respective one or more community persona variables associated with the attribute inconsistency, the logical contradiction, or the statistical anomaly for each of the subset of the virtual personas.

In some embodiments, the computer-implemented method may further comprise: at the virtual persona service: applying, by the one or more processors and for each of the updated virtual personas, a second variable value consistency assessment to identify a subset of the additional virtual personas that each have one or more community persona variables associated with a logical contradiction; discarding, by the one or more processors, the subset of the updated virtual personas associated with the logical contradiction from the batch.

In some embodiments of the computer-implemented method, identifying the respective set of permitted values or the respective distribution for each community persona variable of the set of community persona variables comprises: at the virtual persona service: extracting, by the one or more processors and from one or more digital artifacts, data that indicates the respective set of permitted values or the respective distribution of values for a first subset of the set of community persona variables; generating, by the one or more processors and from the data, the respective set of permitted values or the respective distribution of values for the first subset of the set of community persona variables; and generating, by the one or more processors and using the one or more language learning models, a respective set of permitted values or a respective distribution of values for each of a second subset of the set of community persona variables.

In some embodiments of the computer-implemented method, generating the respective set of permitted values or the respective distribution of values for each of the second subset of the set of community persona variables is based at least in part on identifying that the virtual persona service has failed to extract data corresponding to the second subset of the set of community persona variables from the one or more digital artifacts.

In some embodiments of the computer-implemented method, the one or more batches comprises a first batch and a second batch, and the computer-implemented method further comprises: at the virtual persona service: determining, by the one or more processors and after obtaining the first batch, a difference between a first distribution of values associated with the first batch for a community persona variable and the distribution of values identified for the community persona variable; and updating, by the one or more processors, a prompt of the set of prompts associated with the community persona variable based at least in part on the difference, wherein the second batch is obtained based at least in part on the updated prompt.

In some embodiments of the computer-implemented method, the one or more batches include a set of batches, the set of batches include the first batch and the second batch and is obtained in an iterative sequence, the first batch is obtained before the second batch in the iterative sequence, and the computer-implemented method further comprises: at the virtual persona service: (a) updating, by the one or more processors, the first distribution of values based at least in part on obtaining the second batch; determining, by the one or more processors and after obtaining the second batch, an updated difference between the updated first distribution of values and the distribution of values identified for the community persona variable; updating, by the one or more processors, the prompt of the set of prompts associated with the community persona variable based at least in part on the updated difference, wherein a subsequent batch in the sequence is obtained based at least in part on the updated prompt; and repeating (a) through (c) for each batch of the plurality of batches subsequent to the second batch in an order defined by the iterative sequence, wherein (a) through (c) is repeated until a total quantity of samples associated with the obtained batches exceeds a threshold amount.

In some embodiments, the computer-implemented method further comprises at the virtual persona service: splitting, by the one or more processors, a video asset into a sequence of video chunks; extracting, by the one or more processors and from each video chunk of the sequence, video information comprising a respective audio transcript associated with the video chunk, an interpretation of one or more activities that occur within the video chunk, and a set of frames associated with the video chunk; linking, by the one or more processors, one or more virtual personas of the virtual persona community with an identifier of the video asset; and generating, by the one or more processors, the one or more responses based at least in part on the video information and the one or more virtual personas being linked with the identifier of the video asset.

In some embodiments, the computer-implemented method further comprises: at the virtual persona service: generating, by the one or more processors, a respective profile for each virtual persona of the virtual persona community, wherein the respective profile for each virtual persona comprises a comprises an identifier for the virtual persona and an indication of values for each community persona variable of the set of community persona variables; generating, by the one or more processors, a profile for the virtual persona community, wherein the profile for the virtual persona community comprises an identifier for the virtual persona community and a list of virtual personas within the virtual persona community; and providing, by the one or more processors, the respective profile for each virtual persona and the profile for the virtual persona community to a storage service.

In some embodiments, the computer-implemented method further comprises at the virtual persona service: synchronizing, by the one or more processors, the respective profile for each virtual persona with a database distinct from the storage service.

In some embodiments, the computer-implemented method further comprises at the virtual persona service: generating, by the one or more processors and after performing the synchronizing, reinforcement learning metadata for each of the virtual personas within the virtual persona community; and tuning, by the one or more processors, the one or more language learning models based at least in part on the reinforcement learning metadata.

In some embodiments, the computer-implemented method further comprises: at the virtual persona service: calling an inference endpoint to generate a respective profile image for each of the virtual personas of the virtual persona community and a profile image for the virtual persona community; receiving, from the interference endpoint, the respective profile image for each of the virtual personas and the profile image for the virtual persona community; storing, by the one or more processors, the respective profile image for each of the virtual personas and the profile image for the virtual persona community at a storage service; and outputting, by the one or more processors and via the user interface, the respective profile image for each of the virtual personas of the virtual persona community and the profile image for the virtual persona community.

In some embodiments of the computer-implemented method, identifying, by the one or more processors, the respective set of permitted values or the respective distribution of values for each community persona variable of the set of community persona variables comprises: at the virtual persona service: receiving, by the one or more processors and via the user interface, an indication of the respective set of permitted values or the respective distribution of values for each community persona variable of the set of community persona variables.

In some embodiments of the computer-implemented method, outputting the response includes outputting an opinion that is directly based at least in part on the variable values associated with the virtual persona, thereby mitigating bias associated with one or more responses provided by the virtual persona community.

In some embodiments of the computer-implemented method, each persona-generating prompt of the set of persona-generating prompts is a multi-part prompt that comprises a first part informing a community persona variable selection operation of the language learning model and the second part informing a variable value selection operation of the language learning model, the communication persona variable selection operation and the variable value selection operation for selecting the community persona variables and associated variable values, respectively, of the distinct sets.

In some embodiments of the computer-implemented method, the variable values associated with the plurality of distinct sets of community persona variables are obtained based at least in part on sampling the respective set of permitted values or the respective distribution of values associated with the community persona variables of the plurality of distinct sets.

In some embodiments, a computer-program product may comprise a non-transitory machine-readable storage medium storing computer instructions that, when executed by one or more processors, perform operations comprising: at a virtual persona service: identifying, by the one or more processors, a respective set of permitted values or a respective distribution of values for each community persona variable of a set of community persona variables; constructing, by the one or more processors, a virtual community persona template that indicates the respective set of permitted values or the respective distribution of values for each community persona variable of the set of community persona variables; generating, by the one or more processors, a virtual persona community based at least in part on the virtual community persona template, wherein the generating comprises: providing, by the one or more processors, the virtual community persona template and a set of persona-generating prompts to one or more language models, wherein each persona-generating prompt of the set of persona-generating prompts comprises a set of instructions informing the one or more language learning models to select variable values for a respective subset of the set of community persona variables; obtaining, by the one or more processors, one or more batches of virtual personas from the one or more language learning models based at least in part on the provided virtual community persona template and the set of persona-generating prompts, wherein each batch of the one or more batches comprises a plurality of distinct sets of community persona variables and associated variable values, each distinct set of the plurality of distinct sets mapping to a respective virtual persona; aggregating, by the one or more processors, the one or more batches of virtual personas to form the virtual persona community; receiving, by the one or more processors, a user query and an indication of a virtual persona of the virtual persona community via an interactive user interface; constructing, by the one or more processors, a persona-describing prompt based at least in part on the respective distinct set of community variables and associated variable values corresponding to the indicated virtual persona; providing, by the one or more processors and to the one or more language learning models, the user query and the persona-describing prompt; and outputting, by the one or more processors and from the one or more language learning models, a response to the user query via the interactive user interface based at least in part on the provided user query and the persona-describing prompt.

In some embodiments of the computer-program product, the operations may further comprise: at the virtual persona service: applying, by the one or more processors and for each virtual persona generated by the one or more language learning models for a batch of the one or more batches, a variable value consistency assessment to identify a subset of the virtual personas that each have one or more community persona variables associated with an attribute inconsistency, a logical contradiction, or a statistical anomaly; and updating, by the one or more processors, each virtual persona of the subset of the virtual personas, wherein the updating comprises generating updated values for the respective one or more community persona variables associated with the attribute inconsistency, the logical contradiction, or the statistical anomaly for each of the subset of the virtual personas.

In some embodiments of the computer-program product, the operations may further comprise: applying, by the one or more processors and for each of the updated virtual personas, a second variable value consistency assessment to identify a subset of the additional virtual personas that each have one or more community persona variables associated with a logical contradiction; discarding, by the one or more processors, the subset of the updated virtual personas associated with the logical contradiction from the batch.

In some embodiments of the computer-program product, the operations to identify the respective set of permitted values or the respective distribution for each community persona variable of the set of community persona variables comprises: at the virtual persona service: extracting, by the one or more processors and from one or more digital artifacts, data that indicates the respective set of permitted values or the respective distribution of values for a first subset of the set of community persona variables; generating, by the one or more processors and from the data, the respective set of permitted values or the respective distribution of values for the first subset of the set of community persona variables; and generating, by the one or more processors and using the one or more language learning models, a respective set of permitted values or a respective distribution of values for each of a second subset of the set of community persona variables.

In some embodiments of the computer-program product, generating the respective set of permitted values or the respective distribution of values for each of the second subset of the set of community persona variables is based at least in part on identifying that the virtual persona service has failed to extract data corresponding to the second subset of the set of community persona variables from the one or more digital artifacts.

In some embodiments, a computer-implemented system may comprise: one or more processors; a memory; and a computer-readable medium operably coupled to the one or more processors, the computer-readable medium having computer-readable instructions stored thereon that, when executed by the one or more processors, cause a computing device to perform operations comprising: at a virtual persona service: identifying, by the one or more processors, a respective set of permitted values or a respective distribution of values for each community persona variable of a set of community persona variables; constructing, by the one or more processors, a virtual community persona template that indicates the respective set of permitted values or the respective distribution of values for each community persona variable of the set of community persona variables; generating, by the one or more processors, a virtual persona community based at least in part on the virtual community persona template, wherein the generating comprises: providing, by the one or more processors, the virtual community persona template and a set of persona-generating prompts to one or more language models, wherein each persona-generating prompt of the set of persona-generating prompts comprises a set of instructions informing the one or more language learning models to select variable values for a respective subset of the set of community persona variables; obtaining, by the one or more processors, one or more batches of virtual personas from the one or more language learning models based at least in part on the provided virtual community persona template and the set of persona-generating prompts, wherein each batch of the one or more batches comprises a plurality of distinct sets of community persona variables and associated variable values, each distinct set of the plurality of distinct sets mapping to a respective virtual persona; aggregating, by the one or more processors, the one or more batches of virtual personas to form the virtual persona community; receiving, by the one or more processors, a user query and an indication of a virtual persona of the virtual persona community via an interactive user interface; constructing, by the one or more processors, a persona-describing prompt based at least in part on the respective distinct set of community variables and associated variable values corresponding to the indicated virtual persona; providing, by the one or more processors and to the one or more language learning models, the user query and the persona-describing prompt; and outputting, by the one or more processors and from the one or more language learning models, a response to the user query via the interactive user interface based at least in part on the provided user query and the persona-describing prompt.

### BRIEF DESCRIPTION OF THE FIGURES

FIG. 1 illustrates a schematic representation of a system 100 in accordance with one or more embodiments of the present application;

FIG. 2 illustrates an example method 200 in accordance with one or more embodiments of the present application;

FIG. 3 illustrates an example schematic representation of a persona generation pipeline in accordance with one or more embodiments of the present application; and

FIGS. 4-13 illustrate example data visualization objects of persona variables and persona variable distributions in accordance with one or more embodiments of the present application.

FIG. 14 illustrates an example of a batch generation scheme in accordance with one or more embodiments of the present application.

FIGS. 15A and 15B illustrate an example of an interactive discussion user interface in accordance with one or more embodiments of the present application.

FIGS. 16A and 16B illustrate an example of an interactive aggregation user interface in accordance with one or more embodiments of the present application.

### DESCRIPTION OF THE PREFERRED EMBODIMENTS

The following description of the preferred embodiments of the present application are not intended to limit the inventions to these preferred embodiments, but rather to enable any person skilled in the art to make and use these inventions.

### 1.00 System for Machine-Learning Based Generation of Interactive Virtual Persona Communities

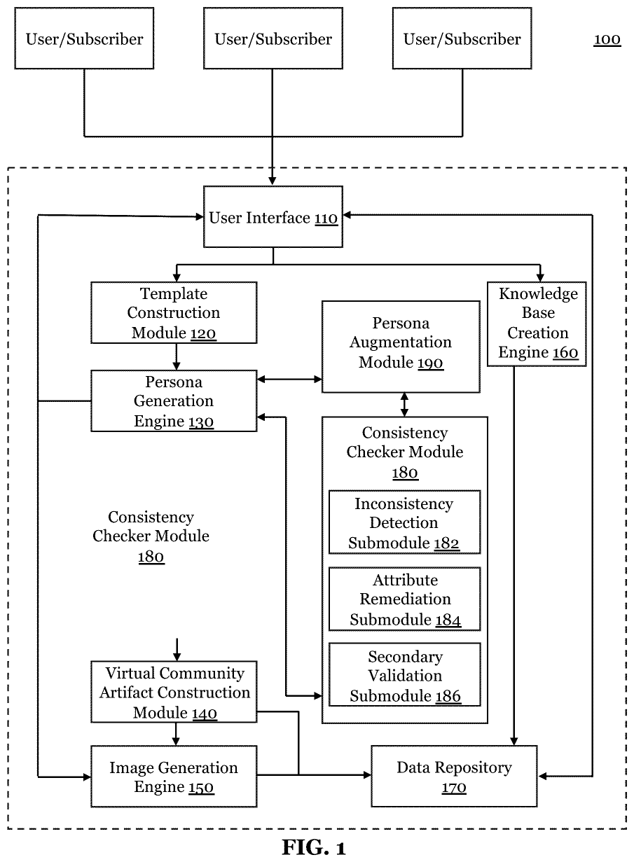

As shown in FIG. 1, a system 100 for machine-learning based generation of interactive virtual persona communities may include a user interface 110, a template construction module 120, a persona generation engine 130, a virtual community artifact construction module 140, an image generation engine 150, a knowledge base creation engine 160, and a data repository 170.

### 1.10 User Interface

The user interface 110 may preferably function to receive user (or subscriber) input from one or more users or subscribers. In one or more embodiments, the user interface 110 may enable one or more users of system 100 to initiate, configure, and/or otherwise manage a generation and interaction with one or more virtual persona communities (as described in 2.10-2.40 below). Accordingly, user interface 110 may be in operable communication with one or more components of system 100 including, but not limited to, template construction module 120, persona generation engine 130, knowledge base creation engine 160, and data repository 170. In various embodiments, user interface 110 may function to send user input data to one or more components of system 100, and/or user interface 110 may function to output or display data from system 100 to one or more users. In some embodiments, user interface 110 may be implemented as a graphical user interface (GUI).

### 1.20 Template Construction Module

The template construction module 120 may preferably function to construct a virtual community persona template for a target virtual community based on one or more user-input virtual community generation parameters (as described in 2.1-2.2 below). In one or more embodiments, template construction module 120 may be operably connected to user interface 110 and may function to receive the user-input virtual community generation parameters from user interface 110. In turn, template construction module 120 may function to construct a virtual community persona template for a target virtual community that may serve as a template for generating one or more virtual personas of the target virtual community. In one or more embodiments, template construction module 120 may additionally function to remediate one or more deficiencies in the user input data by generating one or more deficient or missing virtual community generation parameters, as described in 2.20. In some examples, template construction module 120 may be a microservice specifically programmed with template construction instructions uniquely configured to construct a virtual community persona template.

### 1.30 Persona Generation Engine

The persona generation engine 130 may preferably function to generate one or more virtual personas of a target virtual community based on an input of a virtual community persona template. In one or more embodiments, persona generation engine 130 may source or receive a virtual community persona template for a target virtual community from template construction module 120 and, in turn, persona generation engine 130 may function to generate a population of N virtual personas for the target virtual community. In one or more embodiments, the persona generation engine 130 may function to generate virtual personas based on persona variable values and distributions defined in the virtual community persona template. In some preferred embodiments, persona generation engine 130 may iteratively generate batches of n personas, where n<N, and may automatically adjust the generation of one or more subsequent batch generation iterations based on empirical and target persona variable distributions, as described in 2.30 below. In some embodiments, persona generation engine 130 may be in operable communication with user interface 110 to surface generated virtual personas, and empirical persona variable distributions in real-time to one or more users. Additionally, in some preferred embodiments, persona generation engine 130 may function to construct one or more persona artifacts that may function as data structures to store respective generated virtual personas. In some examples, persona generation engine 130 may be a microservice specifically programmed with persona generation instructions uniquely configured to generate virtual personas.

### 1.40 Virtual Community Artifact Construction Module

The virtual community artifact construction module 140 may preferably function to construct a virtual community digital artifact for a target virtual persona community based on an input of one or more constructed persona artifacts of the target virtual persona community. In one or more embodiments, virtual community artifact construction module 140 may function to construct a virtual community digital artifact that may function as a data structure to store one or more characteristics, parameters, and/or descriptors of a target virtual persona community, as described in 2.40 below. Additionally, in some embodiments, virtual community artifact construction module 140 may function to compute a hash for each constructed persona artifact of the target virtual community, and in turn virtual community artifact construction module 140 may function to embed or include a list of persona artifact hashes in the virtual community digital artifact, as described in 2.40 below. In some embodiments, virtual community artifact construction module 140 may be in operable communication with data repository 170. In some such embodiments, virtual community artifact construction module 140 may function to output constructed virtual community artifacts and/or persona artifacts to data repository 170. In some examples, virtual community artifact construction module 140 may be a microservice specifically programmed with artifact construction instructions uniquely configured to generate virtual personas.

### 1.50 Image Generation Engine

The image generation engine 150 may preferably function to generate one or more images based on an input of generated virtual persona artifacts or generated virtual community digital artifacts. In some embodiments, image generation engine 150 may generate an image that may relate to a likely or plausible appearance or likeness of a virtual persona, as described in 2.30. Additionally, or alternatively, in some embodiments, image generation engine 150 may function to generate a virtual community image that may relate to a likely or plausible appearance or likeness of an average virtual persona member of the virtual community, as described in 2.30. In some examples, image generation engine 150 may be a microservice specifically programmed with image generation instructions uniquely configured to generate images.

### 1.60 Knowledge Base Creation Engine

The knowledge base creation engine 160 may preferably function to create one or more n-dimensional and/or multimodal vector representations of one or more digital assets that may be accessible to and/or otherwise associated with the generated virtual personas of a virtual persona community. In one or more embodiments, knowledge base creation engine 160 may receive one or more digital assets from one or more users via user interface 110, and in turn knowledge base creation engine 160 may function to automatically construct or generate vector representations of the user-specified digital assets. In some preferred embodiments, knowledge base creation engine 160 may construct a knowledge base in data repository 170 to store the vector representation(s) of one or more digital assets, and/or any relevant digital asset metadata such as digital asset identification (ID) values.

In various embodiments, template construction module 120, persona generation engine 130, virtual community artifact construction module 140, image generation engine 150, and/or knowledge base creation engine 160 may implement or otherwise employ one or more machine learning algorithms and/or one or more ensembles of trained machine learning models. In such embodiments, the one or more machine learning algorithms and/or one or more ensembles of trained machine learning models may include one or more of: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), adversarial learning, and any other suitable learning style. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, density-based spatial clustering of applications with noise (DBSCAN), expectation maximization, etc.), a bidirectional encoder representation form transformers (BERT) for masked language model tasks and next sentence prediction tasks and the like, variations of BERT (i.e., ULMFIT, XLM UDify, MT-DNN, SpanBERT, ROBERTa, XLNet, ERNIE, KnowBERT, VideoBERT, ERNIE BERT-wwm, MobileBERT, TinyBERT, GPT, GPT-2, GPT-3, GPT-4 (and all subsequent iterations), LLAMA, LLAMA 2 (and subsequent iterations), ELMo, content2Vec, and the like), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. Each processing portion of the system 100 can additionally or alternatively leverage: a probabilistic module, heuristic module, deterministic module, or any other suitable module leveraging any other suitable computation method, machine learning method or combination thereof. However, any suitable machine learning approach can otherwise be incorporated in the system 100. Further, any suitable model (e.g., machine learning, non-machine learning, etc.) may be implemented in the various systems and/or methods described herein. In some examples, knowledge base creation engine 160 may be a microservice specifically programmed with knowledge base creation instructions uniquely configured to create knowledge bases.

### 1.70 Data Repository

The data repository 170 may preferably function to receive and/or store data collected by and/or generated by system 100, including, but not limited to, one or more collected virtual community generation parameters, one or more generated persona artifacts, one or more virtual community digital artifacts, one or more generated persona and/or virtual community images, one or more n-dimensional or multimodal digital asset vector representations, and/or any other data collected, generated, and/or processed by system 100. Additionally, or alternatively, in one or more embodiments data repository 170 may be queried or accessed by one or more components of system 100 and/or one or more users (via user interface 110) to enable data retrieval and/or data surfacing to data stored by data repository 170. In various embodiments, data repository 170 may be implemented as and/or in operable communication with one or more external data repositories and/or data repository services (e.g., remote servers, cloud storage, external network storage, and/or the like). In some embodiments, data repository 170 may include or be implemented as a plurality of data repositories 170.

### 1.80 Consistency Checker Module

The consistency checker module 180 may preferably function to ensure internal consistency and realism of virtual personas generated by the persona generation engine 130. The consistency checker module 180 may operate by detecting, remediating, and validating persona attributes to ensure that each persona within a generated virtual persona community is free of logical contradictions or highly implausible attribute combinations.

In one or more embodiments, the consistency checker module 180 may include an inconsistency detection submodule 182, which may function to identify inconsistencies within virtual persona profiles by analyzing associated persona attributes. The inconsistencies may include logical contradictions, such as a virtual persona classified as a non-smoker while simultaneously indicating cigarette consumption, or highly implausible attribute combinations, such as a persona with an extremely low age identified as a successful CEO. The inconsistency detection submodule 182 may also identify unlikely attribute combinations, such as a persona holding both an Olympic athlete designation and a PhD in physics, which, while technically possible, may be statistically improbable. The inconsistency detection submodule 182 may leverage reasoning-based techniques, such as large language models, to classify and log identified inconsistencies.

The consistency checker module 180 may also include an attribute remediation submodule 184, which may preferably function to address inconsistencies identified by the inconsistency detection submodule 182. The attribute remediation submodule 184 may remove persona attributes classified as contradictions or highly implausible and subsequently augment incomplete personas by regenerating missing attributes using the persona augmentation module 190. The regeneration process ensures the completeness and coherence of the persona profile while maintaining alignment with target distributions.

To validate the augmented personas, the consistency checker module 180 may further include a secondary validation submodule 186. The secondary validation submodule 186 may perform a final consistency check on each persona to confirm that all inconsistencies have been resolved. If unresolved contradictions are detected, the secondary validation submodule 186 may discard the affected personas to ensure that the resulting persona community includes only valid, internally consistent personas.

In some embodiments, the consistency checker module 180 may operate as part of an iterative persona generation process, analyzing and remediating inconsistencies within each generated batch of personas before prompting the persona generation engine 130 to adjust subsequent iterations. The iterative process may refine community-level persona variable distributions while maintaining internal consistency at the individual persona level. Additionally, the consistency checker module 180 may support the integration of external datasets for persona augmentation, enabling the use of demographic or behavioral data to inform the regeneration of persona attributes and enhance the realism of generated personas. In some examples, consistency checker module 180 may be a microservice specifically programmed with consistency checking instructions uniquely configured to perform consistency checking.

### 1.90 Persona Augmentation Module

The persona augmentation module 190 may preferably function to add persona attributes to incomplete personas (e.g., personas that have had attributes stripped away by the consistency checker module 180). The persona augmentation module 190 may operate in conjunction with the persona generation engine 190 and the consistency checker module 180 to align persona attributes with user-defined parameters or statistical distributions derived from real-world data.

In one or more embodiments, the persona augmentation module 190 may receive incomplete or inconsistent persona profiles from the attribute remediation submodule 184 of the consistency checker module 180. The persona augmentation module 190 may analyze the missing or flagged attributes to identify areas for applying augmentation. For instance, if a persona profile lacks information about professional qualifications or personality traits, the persona augmentation module 190 may synthesize new attributes associated with the professional qualifications or personality traits.

The persona augmentation module 190 may employ machine learning algorithms, such as large language models or probabilistic data generators, to generate augmented attributes. In one or more embodiments, the persona augmentation module 190 may utilize contextual data from external knowledge bases to inform the regeneration process. For example, demographic datasets, behavioral trend reports, or domain-specific knowledge repositories may be incorporated to produce more realistic and contextually accurate persona attributes. The augmented attributes may include multimodal elements such as text, visual descriptors, and multimedia content to ensure a comprehensive representation of each persona.

In some embodiments, the persona augmentation module 190 may operate as a real-time augmentation engine, enabling dynamic updates to persona attributes based on user interactions or new input data. For instance, the Persona Augmentation Module may modify persona profiles in response to changes in user-provided constraints or newly integrated external datasets. This dynamic functionality may enhance the flexibility and adaptability of the generated persona community.

The persona augmentation module 190 may further support the generation of specialized persona profiles tailored for niche applications. For example, personas associated with particular domains (e.g., education, medical, testing) may be enriched with domain-specific attributes to improve their utility in those contexts. The persona augmentation module 190 may ensure that the augmented personas remain internally consistent by operating in coordination with the secondary validation submodule 186 of the consistency checker module 180. In some examples, persona augmentation module 190 may be a microservice specifically programmed with persona augmentation instructions uniquely configured to perform persona augmentation.

### 2.00 Method for Machine-Learning Based Generation of Interactive Virtual Persona Communities

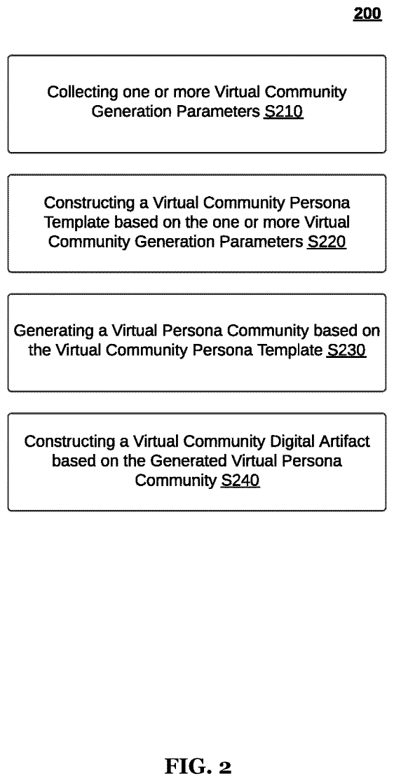

As shown in FIG. 2, a method 200 for machine-learning based generation of interactive virtual persona communities includes collecting one or more virtual community generation parameters S210, constructing a virtual community template based on the one or more virtual community generation parameters S220, generating a virtual persona community based on the virtual community template S230, and constructing a virtual community digital artifact based on the generated virtual persona community S240.

One of ordinary skill in the art will appreciate that the techniques described herein provide technical advantages and practical applications over traditional and existing approaches to real-world opinion simulation. For instance, traditional techniques for simulating real-world opinions often rely on manual processes such as surveys, focus groups, and interviews, which may be time-intensive and may take weeks or months to complete. The techniques described herein, by contrast, leverage large language models (LLMs) and an automated, scalable pipeline to generate virtual personas in near real-time, where each virtual persona may be used to simulate a respective real-world opinion on a topic. Such techniques may bypass the delays associated with manual adjustments. By bypassing the delays, the results of performing real-world opinion simulation may more quickly be utilized for other associated processes.

Additionally, the techniques described herein may mitigate bias. For instance, traditional techniques for collecting opinions may be susceptible to biases, such as a social desirability bias and survey fatigue. Virtual personas may not be susceptible to such biases and may provide a more consistent and authentic representation of the perspective of the associated target audience. Additionally, or alternatively, the techniques described herein may enable the creation of large sample sizes, ensuring greater statistical reliability and reducing an impact of high variance or outliers on the insights generated.

The techniques described herein may further enable flexible segmentation. For instance, each virtual persona may be generated with a corresponding range of demographic, psychographic, and behavior attributes and may be grouped in specific segments based on a particular combination of characteristics. Users may tailor segments according to particular community persona variables, which may enable insights into behaviors and preferences of sub-groups within a target audience.

Virtual personas (e.g., artificial personas) as described herein may enable researchers to replicate real-world audience behaviors and preferences in controlled settings. By creating diverse groups that reflect specific demographics, researchers may simulate discussions, gather insights, and analyze responses to various scenarios. For example, these personas may engage in group chats to share opinions on cultural norms or react to potential product concepts. Surveys filled out by these personas may allow researchers to explore trends and behaviors efficiently without relying on human participants, saving both time and resources while avoiding biases like survey fatigue.

Additionally, artificial personas may allow creators to test ideas and refine tools or objects for specific groups of people. For instance, developers may simulate how a group of young adults in urban settings might respond to a new mobile app or how parents in rural areas might view an educational toy. These personas may provide feedback based on their unique traits, such as lifestyle, interests, and challenges, giving developers valuable insights for crafting objects or tools that better meet the needs of their intended users.

Additionally, artificial personas may enable researchers to explore sensitive topics or study populations where direct engagement might be difficult. For instance, they may model how teenagers in conservative societies perceive sex education or how low-income communities might react to new healthcare policies. These simulations may enable researchers to understand complex social dynamics and anticipate the impact of interventions without facing logistical or ethical challenges involved in real-world studies.

Additionally, artificial personas may enable healthcare researchers to explore responses to public health initiatives or the adoption of new medical treatments. For example, personas modeled after at-risk communities may simulate the uptake of HIV prevention measures or the willingness to participate in vaccination campaigns. These insights may help refine strategies for reaching underserved populations or tailoring health messages to resonate with different cultural or economic groups.

Additionally, artificial personas may enable training of professionals to engage with diverse populations. Teachers may practice explaining concepts to personas representing students with varying needs, while customer service staff may refine their skills by responding to personas simulating upset customers. This type of training may enable individuals to build empathy and communication skills in a safe, low-pressure environment, preparing them for real-world situations.

Additionally, artificial personas may enhance a realistic element of virtual worlds. For instance, a historical reenactment in virtual reality may feature personas with authentic speech and behaviors. Similarly, augmented reality applications may use personas to simulate interactions with people from different walks of life, offering educational or entertaining experiences that simulate the reality.

2.10 Collecting one or more Virtual Community Generation Parameters

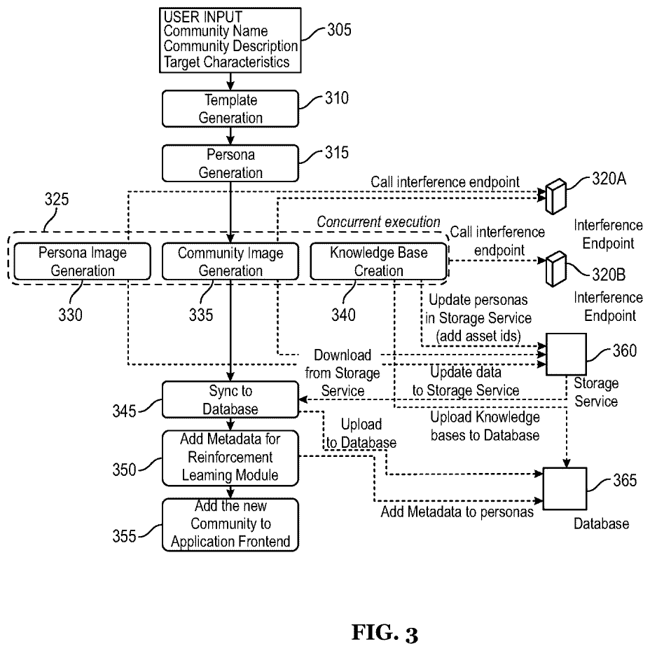

S210, which includes collecting one or more virtual community generation parameters, may function to collect one or more virtual community generation parameters for generating a target virtual persona community. A virtual community generation parameter (sometimes referred to herein as a “community generation parameter”), as generally referred to herein, may relate to a parameter that may function to describe, identify, or otherwise characterize a virtual persona community comprising one or more virtual personas. A virtual persona (sometimes referred to herein as a “persona”), as generally referred to herein, may relate to a computer-generated virtual or digital representation of a distinct individual that may enable an artificial or virtual simulation of one or more interactions with that distinct individual. A virtual persona community (sometimes referred to herein as a “virtual community”), as generally referred to herein, may relate to a distinct set or subset of related virtual personas. In one or more embodiments, method 200 and/or a system or service implementing method 200 may generate a virtual persona community via a virtual persona community generation pipeline, as shown by way of example in FIG. 3. Preferably, the generated virtual persona community may represent a target real-world community, group, or set of individuals in one or more interactions with a user or subscriber. As sometimes used herein, the term “target virtual persona community” or “target virtual community” may relate to a virtual persona community being generated or configured by a current or contemporary operation of method 200 and/or a system or service implementing method 200. As sometimes used herein, the term “target real-world community” or “target existent community” may relate to a community, group, or set of individuals with characteristics that the target virtual community may be intended to represent.

In some examples, S210 may function to identify, using one or more processors at a virtual persona service, a respective set of permitted values or a respective distribution of values for each community persona variable within a set of community persona variables. Community persona variables may encompass demographic, psychographic, and behavioral attributes, including but not limited to age, gender, geographic location, income level, education, occupation, and cultural preferences. The identification process may integrate multiple data sources, such as statistical models, real-world datasets (e.g., census data or market research reports), and predefined templates, to define the allowable value ranges or probability distributions for each variable. For instance, census data may inform the distribution of age or geographic location variables, while behavioral datasets may establish psychographic variable ranges, such as personality traits or purchasing habits. In a non-limiting example, as depicted in FIG. 3, at 305, a system (e.g., a virtual persona service) may identify, from user input, target characteristics (e.g., community persona variables and corresponding sets of permitted values or respective distributions of values) as well as a community name and community description (e.g., for a virtual persona community). It should be noted that at least one of the one or more processors may be specially configured to perform tasks associated with S210.

### Virtual Community Generation Parameters: Persona Variables

Preferably, the one or more virtual community generation parameters may include one or more community persona variables (sometimes referred to herein as persona variables). A community persona variable, as generally referred to herein, may relate to a variable that may have a value or set of values that function to identify and/or otherwise characterize each virtual persona in a virtual persona community. In some preferred embodiments, the one or more virtual community generation parameters may include one or more community persona variables and their chosen values, and/or one or more persona variable distributions, that may function to identify and/or otherwise characterize each virtual persona in a virtual persona community. In some such embodiments, each virtual persona of the virtual persona community must include or be associated with a distinct value for each of the one or more community persona variables of the target virtual persona community. It shall be noted that, as referred to herein, the term “value” may refer to an individual value or a list-type value, such that a distinct value for a list-type persona variable may include a list, array, vector, and/or other collections of individual values and/or of list-type values.

In some embodiments, the one or more community persona variables may include one or more demographic persona variables or characteristics that may function to classify and/or describe individual virtual personas or subsets of virtual personas in the target virtual persona community. In such embodiments, community persona variables may include, but are not limited to, age (e.g., an age or age range), gender, country of birth, nationality, sexual orientation, race, ethnicity, income (e.g., income or income range), education level, occupation, marital status, household size, housing type, geographic location, religion, health status, political affiliation, and/or any other suitable demographic characteristic for classifying, describing, or otherwise identifying an individual virtual persona or a subset of virtual personas.

Additionally, or alternatively, in some embodiments the one or more community persona variables may include emotional, intellectual, and/or personality characteristics that may function to classify and/or describe individual virtual personas or subsets of virtual personas in the target virtual persona community. In such embodiments, emotional, intellectual, and/or personality community persona variables may include, but are not limited to, intelligence or cognitive ability measurements (e.g., IQ scores and/or the like), emotional intelligence measurements (e.g., EQ scores and/or the like), personality type(s) (e.g., Myers-Briggs Type Indicator and/or the like), personality trait(s) (e.g., personality traits of openness, conscientiousness, extraversion, agreeableness, and neuroticism, and/or any other suitable personality traits), and/or any other suitable parameters for characterizing the intellectual, emotional, and/or psychological profile of an individual virtual persona or subset of virtual personas. In some embodiments, the one or more community persona variables may include psychological factors or characteristics encompassing mental and emotional elements that may influence virtual persona behavior including, but not limited to, primary motivators, goals, fears, insecurities, and/or any other suitable psychological factor or characteristic that may define a mental and/or emotional element or state of a virtual persona.

In some embodiments, one or more community persona variables may each include and/or be associated with a distinct community persona variable identifier (sometimes referred to herein as a “persona variable identifier” or “persona variable ID”). As generally referred to herein, a persona variable ID may include a label (e.g., a text label) or other identifying value (e.g., an ID text string, ID number, and/or the like) that may function to identify the corresponding community persona variable. In some embodiments, the persona variable ID may be descriptive of the community persona variable. As a non-limiting example, a community persona variable that may define an age or age range for the virtual community may include a corresponding text label persona variable ID of “Age,” “Age Range,” or the like.

In some embodiments, one or more community persona variables may each include or be associated with a persona variable data type. In such embodiments, a persona variable data type may define, identify, or otherwise relate to a type or classification of a value that a corresponding community persona variable may hold. In various embodiments, persona variable data types may include, but are not limited to, numbers or number types (e.g., number, integer, float, double, and/or the like), character or character types, string or string types, Boolean, list or list types (e.g., list, array, vector, and/or the like), and/or any other suitable data type for a corresponding community persona variable.

In some embodiments, one or more community persona variables may each include a distinct persona variable value range for the corresponding community persona variable in the target virtual persona community. A persona variable value range (sometimes referred to herein as a persona variable range), as generally referred to herein, may relate to a set or range of one or more possible values for the corresponding community persona variable that a virtual persona may have in the target virtual persona community. As a non-limiting example, a community persona variable for age may include a persona variable range that defines the set of possible ages that a virtual persona may have in the target virtual persona community. In some embodiments, the persona variable range may relate to or define an entire set or range of possible values for the corresponding community persona variable (i.e., the corresponding community persona variable may not have any values outside of those defined by the persona variable value range). Alternatively, in some embodiments, the persona variable range may be a partial persona variable range that may relate to or define a partial set or partial range of possible values for the corresponding community persona variable (i.e., the corresponding community persona variable may have values outside of those defined by the partial persona variable range).

### Virtual Community Generation Parameters: Persona Variable Distributions

In some embodiments, one or more community persona variables may each include or be associated with a distinct persona variable value distribution (sometimes referred to herein as a persona variable distribution). A persona variable value distribution, as generally referred to herein, may identify or define a target spread or frequency of persona variable values for a corresponding community persona variable among virtual personas in a virtual persona community. In embodiments in which a community persona variable includes a persona variable value range, the persona variable distribution may identify or define a target spread or frequency for one or more (or each) persona variable value of the persona variable value range for the corresponding community persona variable. In various embodiments, a persona variable value distribution may include, define, or relate to a discrete distribution or a continuous distribution. In one or more embodiments, a persona variable value distribution may include, define, or relate to a probability distribution (e.g., a binomial distribution, a hypergeometric distribution, a Poisson distribution, a Gaussian distribution, a uniform distribution, a Bernoulli distribution, a geometric distribution, an exponential distribution, and/or any other suitable probability distribution for defining a distribution of a community persona variable). In some embodiments, a persona variable value distribution may define a target count or quantity for one or more (or each) persona variable value of a persona variable value range for a corresponding community persona variable. It shall be noted that a virtual community may include one or more persona variables associated with or defined by different types of persona variable distributions.

In some embodiments, a persona variable distribution may define a target frequency or share for each possible distinct persona variable value of a community persona variable, such that each distinct persona variable value (e.g., each distinct possible value of the persona variable defined by the persona variable value range) may be associated with a distinct target distribution frequency or share that may define a target percentage or share of virtual personas out of the total virtual community population that may have (i.e., be generated with) the corresponding distinct persona variable value. As a non-limiting example, a community persona variable for age may include a persona variable value range of 18-34 (e.g., 18, 19, 20, 21, . . . , 34) that may define the set of all possible ages a virtual persona may be generated within a target virtual persona community (i.e., in the target virtual community, a virtual persona may only have an age value from 18-34). In such an example, the community persona variable for age may additionally include a corresponding persona variable value distribution that defines a target frequency for each age in the age persona variable value range. In such an example, for a total number N of virtual personas in the virtual persona community, the persona variable distribution may include target frequency values a/N, b/N, c/N, d/N, . . . , q/N, where each distinct frequency value (e.g., a/N) corresponds to a distinct age persona variable value (e.g., age 18) in the persona variable value range of 18-34. In such an example, a, b, c, d, . . . , q may each represent a target number of virtual personas to be generated with the corresponding age persona variable value in a virtual persona community of N virtual personas. It shall be noted that the above example is non-limiting, and a target frequency or share value in a parameter distribution may be represented as a percentage (e.g., a %, b %, c %, etc., where a, b, and c are numerical values), a fractional share (a/N, b/N, c/N, etc., where a, b, c, and N are numerical values), a numerical value or decimal value (e.g., a/100, b/100, c/100, etc., or the decimal equivalents thereof, where a, b, and c are numerical values), and/or any other suitable format for representing percentages or frequencies.

In some embodiments, one or more persona variable distributions may be based on input (e.g., user input) statistical or demographic data, such that the one or more persona variable distributions may represent distributions of corresponding persona variables in a target real population of individuals. In such embodiments, basing one or more persona variable distributions on real statistical or demographic data may provide the technical benefit of enabling the virtual persona community to accurately represent the target real population of individuals. In some such embodiments, S210 may function to identify and/or extract the one or more persona variable distributions based on the input statistical or demographic data.

In one or more preferred embodiments, the one or more virtual community generation parameters of a target virtual persona community may include a virtual community population parameter. In such preferred embodiments, a virtual community population parameter may define a total number N of virtual personas in the target virtual persona community. In some such embodiments, one or more persona variable distributions may be based on or otherwise relate to the virtual community population parameter (e.g., persona variable distributions that may be based on a target frequency or share of the total population).

### Virtual Community Generation Parameters: Virtual Community Descriptors

In some preferred embodiments, the one or more virtual community generation parameters may include one or more virtual community descriptors. In some such embodiments, the one or more virtual community descriptors for a target virtual community may include a virtual community name or label (e.g., a text name or text label for the target virtual community), a virtual community ID (e.g., a numeric or text-based ID), a virtual community description (e.g., a text summary or text description of a virtual community), and/or any other descriptive data or content that may function to describe or characterize a virtual persona community.

### Virtual Community Generation User Interface

In some preferred embodiments, S210 may function to implement a virtual community generation user interface that may enable one or more users to initiate and/or configure a generation of a target virtual persona community. In some such embodiments, the virtual community generation user interface may enable the one or more users to input, edit, and/or otherwise modify the one or more virtual community generation parameters; that is, in some such embodiments, S210 may function to collect the one or more virtual community generation parameters from one or more users via the virtual community generation user interface. In some preferred embodiments, the virtual community generation user interface may be implemented as a graphical user interface (GUI).

In some embodiments, the virtual community generation user interface may include one or more interface input objects that may enable the user interface to obtain or receive user input. In some embodiments, the input objects may include a virtual community name or label input object that may function to receive, as input, a virtual community name or label. In some embodiments, the input objects may include a virtual community description input object that may function to receive, as input, a text-based virtual community description. In some embodiments, the input objects may include a virtual community population input object that may function to receive, as input, a virtual community population parameter for the target virtual persona community. In various embodiments, the one or more interface input objects may include or be implemented as one or more input control objects including, but not limited to, text boxes, text areas, text input fields, numeric input fields, and/or any other suitable interface input control object.

In various embodiments, the virtual community generation user interface may include one or more persona variable input interface object groups that may each function to obtain or receive user input relating to an input community persona variable. In some embodiments, a persona variable input interface object group may include a persona variable ID input interface object (e.g., a text input, a numeric input, and/or the like) that may function to obtain or receive input of a persona variable ID. In some embodiments, a persona variable input interface object group may include a persona variable range input interface object (e.g., a text input, a numeric input, and/or the like) that may function to obtain or receive input of a persona variable range (e.g., a range or set of possible values for a corresponding persona variable). In some embodiments, a persona variable input interface object group may include a persona variable distribution input interface object (e.g., a text input, a numeric input, an/or the like) that may function to obtain or receive input of a persona variable distribution. In some embodiments, one or more of the above identified input interface objects may include or be implemented as selection control interface objects that may include, but are not limited to, checkboxes, radio buttons, drop-down menus, toggle switches, slider controls, list boxes, combo boxes, multi-select lists, segmented controls, and/or any other suitable selection control interface object.

In some embodiments, a persona variable input interface object group may include a persona variable data input interface object that may function to obtain or receive a dataset or data objects that may relate to a persona variable. In such embodiments, a persona variable data input interface object may enable a user upload of one or more data objects (e.g., a data file, a data table, a dataset, and/or the like) that may include data that may relate to or define one or more aspects of a persona variable, a persona variable range, and/or a persona variable distribution.

It shall be noted that collected, user-input, and/or user-specified persona variables, i.e. the subset of persona variables for which persona variable values and/or persona variable distributions may have been user-specified or user-defined, may sometimes be referred to herein as “target characteristics” or “target community characteristics.”

In some examples, to identify the respective set of permitted values or the respective distribution of values for each community persona variable of the set of community persona variables, S210 may receive, using one or more processors and via a user interface (e.g., the virtual community generation user interface), an indication of the respective set of permitted values or the respective distribution of values for each community persona variable. The user interface may enable users to input or modify these values and distributions interactively. For example, a user may specify that the variable “age” should follow a normal distribution with a mean of 35 and a standard deviation of 10, or that the variable “gender” should be equally distributed among male, female, and non-binary options. This input may be facilitated through drop-down menus, sliders, or data upload functionalities, enabling users to define distributions tailored to their research objectives or target demographic. By enabling the direct input of these parameters via the user interface, S210 may ensure flexibility and adaptability in defining persona attributes, allowing the virtual persona community to be customized for a wide range of applications. This process ensures that the identified distributions or values are integrated into the persona generation pipeline.

### Persona Augmentation

In some examples, S210 may extract, using one or more processors at the virtual persona service, data from one or more digital artifacts that indicates the respective set of permitted values or the respective distribution of values for a first subset of the community persona variables. Digital artifacts may include structured datasets, such as census data, market research reports, survey results, or publicly available demographic records, as well as unstructured data sources like textual documents, multimedia content, or academic publications. For example, a survey dataset might provide age distributions segmented by geographic region, while a market research report could specify typical income ranges for specific occupations. The extraction process may involve parsing, cleaning, and organizing the data to identify relevant attributes and their associated values or distributions.

Once the data is extracted, S210 may generate, using one or more processors, the respective set of permitted values or the respective distribution of values for the first subset of community persona variables. This process may involve statistical analysis, such as calculating probability distributions, defining value ranges, or identifying patterns within the extracted data. For example, S210 may process survey responses to determine the probability distribution of educational attainment across different age groups. These generated distributions or value sets may be mapped to the virtual community persona template, ensuring alignment with the intended demographic or psychographic characteristics.

For a second subset of community persona variables where direct data may not be available or sufficient, S210 may utilize one or more language learning models to generate the respective set of permitted values or the respective distribution of values. Language learning models, such as large language models (LLMs), may infer these values or distributions based on patterns learned from extensive training datasets. For example, given inputs such as geographic location and occupation, an LLM may predict likely personality traits, consumer preferences, or social behaviors for the second subset of persona variables. This process may involve generating distributions that complement the first subset and align with the broader virtual community persona template.

In some examples, S210 may generate the respective set of permitted values or the respective distribution of values for each of the second subset of community persona variables when it identifies using one or more processors, that the virtual persona service has failed to extract corresponding data from one or more digital artifacts. This identification process may involve validation checks during data extraction, where the system compares expected variables against available data. For instance, if digital artifacts such as census reports or survey datasets provide no information on psychographic variables like personality traits or emotional tendencies, the system flags these variables as part of the second subset.

As described herein, S220 may perform persona augmentation to regenerate missing persona variables for incomplete personas after detecting inconsistencies or gaps in their profiles. In some examples, P:={AgeGroup, Gender, CountryOfCurrentResidence, . . . } may denote a set of all possible persona attributes for which values may be generated in a full persona generation step of the persona generation pipeline. An incomplete persona p may only possess values for a subset of those attributes Pₚ⊆P. Persona augmentation may be utilized to generate values for all remaining attributes such that Pₚ=P (e.g., through a machine learning model, such as an LLM). For example, an incomplete persona with known attributes such as age, gender, and geographic location may have education level or occupation inferred through persona augmentation.

In some examples, S220 may also utilize persona augmentation to enhance existing datasets by integrating missing demographic variables. Structured datasets, such as survey data, may provide only partial information about participants. For instance, a health survey might include age, gender, and medical history but omit socioeconomic attributes like education level or occupation. By applying the persona augmentation process, S220 may infer these missing variables and create enriched personas that preserve the original dataset's integrity while adding value. For example, given attributes such as age, gender, and country of residence, an LLM may infer likely educational attainment or occupational categories by leveraging patterns learned from large-scale datasets. This enriched data may enable more detailed analyses, such as targeted healthcare interventions or market segmentation strategies, without requiring additional data collection efforts.

In some examples, S220 may synergize with traditional statistical modeling to leverage known lower-dimensional distributions of demographic variables. For datasets sourced from census data or other reliable statistical resources, S220 may utilize traditional sampling methods to generate initial demographic variables that accurately reflect real-world distributions. For example, S220 may sample age, gender, and geographic location distributions directly from census data, ensuring the generated personas align with actual population demographics. Once these demographic variables are sampled, S220 may apply persona augmentation to infer and generate the remaining persona variables, such as personality traits, lifestyle preferences, or behavioral attributes, using LLMs. For instance, given sampled demographic attributes, an LLM may predict corresponding psychographic attributes like personality type or consumer behavior.

One of ordinary skill in the art will appreciate that the techniques described herein provides significant technical advantages and practical applications over existing methods for generating virtual personas. Other methods for addressing incomplete persona profiles may utilize manual intervention or static imputations, resulting in limited adaptability and accuracy. The techniques described herein, meanwhile, implement a persona augmentation process that dynamically regenerates missing or inconsistent attributes using machine learning models, such as LLMs. By enabling real-time augmentation of incomplete personas, the system ensures that every persona in the virtual community is complete and aligned with target distributions.

### Virtual Community Augmenting Data

In some embodiments, the one or more virtual community generation parameters may include one or more pieces of virtual community augmenting data (sometimes referred to herein as community augmenting data). As generally referred to herein, virtual community augmenting data may relate to one or more data elements, assets, items, or other pieces of data that may represent information that may be available to the virtual persona(s) of a virtual persona community. In some embodiments, virtual community augmenting data may include video data, audio data, image data, text data, and/or the like that may represent one or more media content assets or the like that may be made available to the virtual persona(s) of a virtual persona community. In such embodiments, method 200 and/or a system or service implementing method 200 may function to generate a virtual persona community that simulates a real set of individuals that may have consumed the corresponding media content.

In one or more embodiments, virtual community augmenting data may include and/or be converted to one or more n-dimensional vector representations of video data, audio data, image data, text data, and/or the like. In some embodiments, the virtual community augmenting data may include and/or be converted to one or more multimodal embeddings that may represent one or more asset modalities including, but not limited to, video, audio, image, text, and/or the like. In some embodiments, the virtual community augmenting data may be stored in a virtual community augmenting data knowledge base that may enable one or more systems or services to access to the virtual community augmenting data during generation of the virtual persona community and/or during generation of virtual personas.

In some embodiments, virtual community augmenting data may include one or more internet links (e.g., a URL), file paths, and/or other routing paths that may point to or direct method 200 and/or a system or service implementing method 200 to one or more virtual community augmenting data assets (e.g., video data, audio data, image data, text data, and/or the like). In some embodiments, each piece or asset of virtual community augmenting data may include one or more elements of metadata including one or more augmenting data labels, one or more augmenting data IDs, one or more augmenting data summaries or descriptions, and/or any other piece of metadata descriptive of or otherwise associated with a piece or asset of virtual community augmenting data.

2.20 Constructing a Virtual Community Persona Template based on the one or more Virtual Community Generation Parameters

S220, which includes constructing a virtual community persona template based on the collected virtual community generation parameters, may function to construct a virtual community persona template that may inform a generation of one or more virtual personas in a target virtual persona community. A virtual community persona template (sometimes referred to herein as a community persona template or a virtual community template), as generally referred to herein, may relate to a data object or data structure that may include or otherwise define a set of possible or permitted values for one or more community persona variables based on the virtual community generation parameters. In some preferred embodiments, the community persona template may additionally include a persona variable distribution for each community persona variable. In some embodiments, constructing the virtual community persona template may include implementing a template generation machine learning model that may generate one or more persona variable ranges and/or one or more persona variable distributions.

In some examples, S220 may construct, using one or more processors, a virtual community persona template that defines the respective set of permitted values or distributions of values for each community persona variable within a specified set. This template may serve as a structured framework for persona generation, encompassing variables such as demographic attributes (e.g., age, gender, geographic location), psychographic traits (e.g., personality types, emotional characteristics), and behavioral patterns (e.g., purchasing habits, lifestyle preferences). The construction process may integrate data from external sources, such as census data, market research reports, or domain-specific knowledge bases, to establish realistic and contextually appropriate ranges or statistical distributions for each variable. For example, census data may define population-level distributions for geographic location and age, while psychographic and behavioral datasets may inform variable value distributions for traits like personality or consumer behavior. In a non-limiting example, as depicted in FIG. 3, a system (e.g., a virtual persona service) may receive, at 305 via user input, a community name, a community description, and target characteristics and may use the community name, the community description, and/or the target characteristics at 310 to generate a template. It should be noted that at least one of the one or more processors may be specially configured to perform tasks associated with S220.

### Persona Template: Persona Variables and Persona Variable Distributions

Preferably, the virtual community persona template for a target virtual persona community may include or define every possible or permitted value for the one or more community persona variables that each individual virtual persona of the target virtual persona community may assume. Additionally, in some preferred embodiments, the virtual community persona template may include persona variable distributions for the one or more community persona variables.

In some preferred embodiments, S220 may function to construct the community persona template based on the collected virtual community generation parameters. In some embodiments, S220 may function to identify one or more community persona variables, persona variable ranges, and/or persona variable distributions included in the virtual community generation parameters (as described in 2.1), and in turn S220 may function to construct the community persona template to include the identified community persona variable(s), persona variable range(s), and/or persona variable distribution(s). Additionally, or alternatively, in one or more embodiments, S220 may function to configure one or more persona variable distributions to be included in the community persona template based on one or more user-input or user-sourced distributional or statistical data in the virtual community generation parameters.

In some embodiments, S220 may function to implement a template generation machine learning model (or an ensemble of models) that may function to construct or generate the virtual community persona template based on an input that may include one or more virtual community descriptors of the target virtual community, such as the target virtual community name and the target virtual community description, and the collected or user-specified community persona variables, persona variable values, and/or persona variable distributions (e.g., the target community characteristics collected in S210). In some embodiments, the template generation model may function to generate, as output, the virtual community persona template based on the input to the model.

In some embodiments, the template generation model may include a large language model and/or an ensemble of large language models. In some embodiments, the template generation model may include one or more transformer models, one or more embeddings models, one or more neural networks, and/or any other suitable model for generating persona variable values, persona variable ranges, and/or persona variable distributions. In some embodiments, the template generation model may be implemented remotely and/or as a service (e.g., a remote service and/or a third party service). In some such embodiments, S220 may function to configure, manage, provide inputs to, and receive outputs from the template generation model via one or more API protocols, requests, and/or the like.

### Persona Template: Generation of Deficient Variable Ranges and Distributions

In some embodiments, S220 may function to identify one or more deficient community persona variables in the virtual community generation parameters that may have corresponding deficient persona variable values, persona variable ranges, and/or persona variable distributions. In such embodiments, deficient persona variables, values, ranges, and/or distributions may include persona variables, values, ranges, and/or distributions that may be incomplete, undefined (e.g., absent), and/or otherwise unavailable (e.g., persona variables, values, ranges, distributions, that may not have been collected from a user). In some such embodiments, S220 may function to generate persona variable values, persona variable ranges, and/or persona variable distributions for each identified deficient community persona variable.

In some preferred embodiments, S220 may function to identify one or more deficient persona variables based on a comparison between the target community characteristics (i.e., the user-specified persona variables, values, and/or distributions collected by S210) and the persona variable(s) of a base persona template. A base persona template, as generally referred to herein, may relate to a predefined persona template that may include all persona variables (sometimes referred to herein as base template persona variables) that may define a virtual persona and the corresponding persona variable data types. In one or more embodiments, the base persona template may function as a “ground truth” that may indicate all persona variables that may be required to define a virtual persona. In some preferred embodiments, S220 may function to compare the base template persona variables with the one or more user-specified persona variables (i.e., the target community characteristics), and in turn S220 may function to identify any base template persona variable that may lack a corresponding user-specified persona variable as a deficient persona variable. That is, in some embodiments, any base template persona variable that is not defined or specified by a user (e.g., collected from a user as in S210) may be identified as a deficient persona variable.

In some embodiments, the template generation model may include, and/or additionally function as, a persona variable remediation model. In one or more embodiments, the persona variable remediation model may relate to a machine learning model (or an ensemble of models) that may be configured to generate feasible persona variable value(s), persona variable range(s), and/or persona variable distribution(s) for each deficient persona variable. In some such embodiments, S220 may function to provide, for each deficient persona variable, an input to the persona variable remediation model that may include the deficient persona variable and a persona variable ID and/or a persona variable data type associated with the deficient persona variable. Additionally, in some embodiments, S220 may function to include the target community characteristics (i.e., the subset of persona variables for which values and/or distributions are user-specified), and/or one or more virtual community descriptors of the target virtual community, such as the target virtual community name and the target virtual community description, in the input for each deficient persona variable.

In some preferred embodiments, the persona variable remediation model may function to generate values and/or distributions for deficient persona variables in an iterative procedure. In some embodiments, for each identified deficient persona variable, if the deficient persona variable lacks corresponding user-specified persona variable values and/or a user-specified persona variable distribution, the persona variable remediation model may generate one or more candidate persona variable values, or a range or set of candidate persona variable values, based on the input to the persona variable remediation model. In such embodiments, candidate persona variable values or ranges may be generated as realistic or appropriate (i.e., plausible) values for the deficient persona variable based on the content and context of the input(s) to the persona variable remediation model. In turn, in such embodiments, if the deficient persona variable lacks a corresponding user-specified persona variable distribution, the persona variable remediation model may compute or generate a plausible, fair, and/or unbiased candidate persona variable distribution for the deficient persona variable based on the input(s) to the persona variable remediation model. In such embodiments, the candidate persona variable distribution may relate to a distribution of persona variable values (e.g., user-specified persona variable values or candidate persona variable values) of the corresponding deficient persona variable that may be consistent with a distribution of the deficient persona variable in the target real-world community. Subsequently, in one or more embodiments, the persona variable remediation model may normalize the generated candidate persona variable values and/or the generated candidate persona variable distribution. It shall be noted, in some embodiments, the persona variable remediation model may normalize the generated candidate persona variable values and/or distributions based on the corresponding persona variable, persona variable data type, and/or persona variable values. In various embodiments, the persona variable remediation model may base the normalization on normalization scale(s) of one and/or scale(s) other than one. In turn, in one or more embodiments, the persona variable remediation model may function to format the generated candidate persona variable values and/or the generated candidate persona variable distribution (e.g., format candidate values and/or the candidate distribution according to the corresponding persona variable data type of the deficient persona variable).

It shall be noted that, in one or more embodiments, for each deficient persona variable, the persona variable remediation model may skip the generation of candidate persona variable values if the deficient persona variable has corresponding user-specified persona variable values and/or a user-specified persona variable distribution (e.g., values or distribution(s) in the target characteristics collected in S210). Additionally, or alternatively, in one or more embodiments, for each deficient persona variable, the persona variable remediation model may skip the generation of a candidate persona variable distribution if the deficient persona variable has a corresponding user-specified persona variable distribution (e.g., a distribution in the target characteristics collected in S210). Therefore, in some embodiments, the persona variable remediation model may function to selectively generate candidate values and/or candidate distributions that may be missing from collected/user input, as may be determined based on a comparison between the collected/user input and the base persona template.

In some embodiments, for each deficient persona variable, S220 may function to initiate or prompt the persona variable remediation model to identify and remediate any biases in the candidate persona variable distribution and/or the candidate persona variable values or range, such that any finalized candidate persona variable distributions and/or candidate persona variable values or ranges may avoid bias. As a non-limiting example, for a persona variable of ethnicity, the persona variable remediation model may initially generate a biased candidate persona variable distribution that may over-represent and/or under-represent one or more persona variable values (e.g., one or more ethnicity values) in the target virtual community. In such an example, S220 may function to initiate or prompt the persona variable remediation model to remediate the bias in the candidate persona variable distribution such that a finalized candidate persona variable distribution may avoid the overrepresentation and/or underrepresentation.

In some embodiments, the template generation model and/or the persona variable remediation model may include one or more machine learning models (e.g., large language models and/or the like) that may leverage learned statistical patterns, associations, and correlations between human characteristics based on one or more diverse training corpora to generate plausible candidate persona variable values and distributions, and/or to identify and remediate biases in candidate persona variable distributions.

In some embodiments, the template generation model may function to identify, for each deficient persona variable, one or more finalized candidate persona values, a finalized range of candidate persona values, and/or a finalized candidate persona variable distribution. In some embodiments, the one or more finalized candidate persona values, finalized range of candidate persona values, and/or finalized candidate persona variable distribution may be identified based on a completion of normalization and formatting, and/or a completion of bias removal, as described above. In some embodiments, upon finalization of corresponding candidates, the template generation model may function to convert or identify each deficient persona variable as a sufficient or completed persona variable based on including, appending, or otherwise associating the deficient persona variable with the corresponding finalized candidate persona values, finalized range of candidate persona values, and/or finalized candidate persona variable distribution. In turn, in some embodiments, the template generation model may function to incorporate, store, or otherwise include each sufficient or completed persona variable along with the corresponding finalized candidate persona values, finalized range of candidate persona values, and/or finalized candidate persona variable distribution, in the generated or output virtual community persona template.

2.30 Generating a Virtual Persona Community based on the Virtual Community Persona Template

S230, which includes generating a virtual persona community based on the virtual community persona template, may function to automatically generate a target virtual persona community by generating one or more virtual personas of the target virtual persona community based on the community persona variables, persona variable ranges, and/or the persona variable distributions of the constructed virtual community persona template. In some embodiments, S230 may function to generate a virtual persona artifact for each generated virtual persona. A virtual persona artifact, as generally referred to herein, may relate to a data structure that may include data values (e.g., key-value pairs, text data values, string data values, numerical data values, Boolean data values, binary data values, and/or the like) for each community persona variable for a corresponding distinct virtual persona. In various embodiments, a virtual persona artifact may include any or all data or metadata that may function to identify or characterize the corresponding distinct virtual persona.

In some examples, S230 may generate, using one or more processors, a virtual persona community based on the virtual community persona template. To generate the virtual persona community, S230 may provide the virtual community persona template and a set of persona-generating prompts to one or more language learning models. Each persona-generating prompt may include a set of instructions designed to inform the language learning models on selecting variable values for a specific subset of the community persona variables. For instance, a prompt may direct the model to generate demographic variables such as age, gender, and geographic location while adhering to the statistical distributions defined in the template.

Upon receiving the template and persona-generating prompts, the language learning models may generate one or more batches of virtual personas. Each batch may include multiple distinct sets of community persona variables and their associated variable values, where each of these distinct sets may map to a respective virtual persona. For example, one batch may include personas with attributes such as {Age: 30, Gender: Female, Geographic Location: Urban}, while another batch may feature {Age: 45, Gender: Male, Geographic Location: Rural}. These sets may map to individual virtual personas, with each persona reflecting a unique combination of attributes guided by the parameters defined in the virtual community persona template and the provided prompts. The iterative nature of this process ensures alignment with the intended distributions and characteristics specified in the template.

Once the one or more batches of virtual personas are obtained, S230 may aggregate these batches to form a virtual persona community. This aggregation process may involve consolidating individual personas. Performing aggregation may ensure that the virtual persona community follows the target distributions for all community persona variables (e.g., as defined by the corresponding distribution of values set for the community persona variables). In a non-limiting example, as illustrated with reference to FIG. 3, S230 may generate the virtual persona community.

In some examples, the persona-generating prompts may be multi-part persona-generating prompts, where each prompt includes a first part informing a community persona variable selection operation and a second part informing a variable value selection operation of the language learning model. The first part of the prompt may direct the language learning model to identify which community persona variables from the set should be selected for the persona being generated. For example, the prompt may instruct the model to prioritize selecting variables such as “age,” “occupation,” and “geographic location” for personas representing working professionals. This part ensures that the generated persona includes a relevant subset of attributes aligned with the context of the virtual persona community.

The second part of the prompt may inform the variable value selection operation, guiding the language learning model to assign specific values to the selected community persona variables based on predefined distributions or ranges. For instance, if “age” is selected as a variable, the second part of the prompt may specify that the value should be drawn from a normal distribution with a mean of 35 and a standard deviation of 5. Similarly, for the variable “occupation,” the prompt may constrain the selection to options such as “engineer,” “teacher,” or “manager,” reflecting the characteristics of the target population.

This multi-part prompt structure ensures a sequential and logically consistent approach to persona generation, first determining the relevant variables and then assigning contextually appropriate values to those variables. By embedding this hierarchical logic into the persona-generating prompts, S230 may enable the language learning models to generate virtual personas that are aligned with the distributions and constraints defined in the virtual community persona template.

In some examples, S230 may obtain the variable values associated with the multiple distinct sets of community persona variables based on sampling the respective set of permitted values or the respective distribution of values associated with the community persona variables. This sampling process ensures that the values assigned to each community persona variable adhere to the predefined ranges or statistical distributions established in the virtual community persona template. For example, if the permitted values for the “age” variable follow a normal distribution with a mean of 30 and a standard deviation of 5, S230 may sample individual age values for virtual personas that align with this distribution. Similarly, for categorical variables such as “occupation,” sampling may involve probabilistic selection based on predefined weights, such as a 40% probability for “engineer,” 30% for “teacher,” and 30% for “artist.”

Sampling may be implemented using randomization techniques, probabilistic models, or advanced sampling algorithms such as Monte Carlo methods to ensure diversity and statistical fidelity across the generated personas. For continuous variables, S230 may generate values using parametric distributions (e.g., normal, uniform) or non-parametric methods derived from empirical data. For categorical variables, S230 may leverage discrete sampling methods that account for the target population proportions.

By obtaining variable values through systematic sampling, S230 ensures that the generated virtual persona community reflects the target population's diversity and statistical characteristics. This approach allows for the creation of realistic and representative personas, supporting applications such as demographic analysis, market research, and behavioral simulations. The sampling mechanism also ensures adaptability, enabling S230 to dynamically adjust to updates in the virtual community persona template or user-defined constraints. It should be noted that at least one of the one or more processors may be specially configured to perform tasks associated with S230.

### Generating Virtual Personas

Preferably, generating the target virtual community may include generating one or more virtual personas of the target virtual community based on the community persona variables, persona variable ranges, and/or the persona variable distributions of the constructed virtual community persona template. In some preferred embodiments, S230 may function to generate a total number N of virtual personas of the target virtual persona community (i.e., a virtual community that may have a population of N virtual personas).

In some preferred embodiments, S230 may implement a virtual persona generation machine learning model (or an ensemble of models) that may generate an output of one or more virtual personas and/or one or more virtual persona artifacts that may represent one or more corresponding generated virtual personas. In some embodiments the virtual persona generation model (sometimes referred to herein as the persona generation model) may include a large language model and/or an ensemble of large language models. In some embodiments, the virtual persona generation model may include one or more transformer models, one or more embeddings models, one or more neural networks, and/or the like. In some embodiments, the virtual persona generation model may be implemented remotely and/or as a service (e.g., a remote service and/or a third party service). In some such embodiments, S230 may function to configure, manage, provide inputs to, and receive outputs from the virtual persona generation model via one or more API protocols, requests, and/or the like.

In some preferred embodiments, S230 may function to generate one or more batches of n of virtual personas, where n<N. In some such embodiments, S230 may function to iteratively generate the one or more batches of n virtual personas based on initiating and/or executing a batch generation iteration for generating each batch of n virtual personas until a quantity of generated virtual personas is equal to N. In some embodiments, S230 may function to implement or direct the virtual persona generation model to generate each batch of virtual personas. In some embodiments, for each batch of n virtual personas in the target virtual persona community, the virtual persona generation model may generate n personas based on an input to the virtual persona generation model of the constructed virtual community persona template corresponding to the target virtual community.

In some preferred embodiments, for each batch generation iteration that may generate a batch of n virtual personas, the virtual persona generation model may receive, as input, the constructed virtual community persona template that may include all persona variables for the target virtual persona community, all possible values of the persona variables, and persona variable distributions. In turn, the virtual persona generation model may procedurally generate each of the n virtual personas of the batch based on executing one or more persona generation stages. In some embodiments, the procedural generation of each of the n virtual personas in one or more persona generation stages may be implemented and/or executed as a zero-shot chain-of-thought process. In some embodiments, at each persona generation stage the persona generation model may function to compute or identify one or more distinct values for one or more persona variables for the current (target) virtual persona being generated of n virtual personas in the batch.

In some embodiments, the one or more persona generation stages may include a demographic generation stage. In such embodiments, the virtual persona generation model may generate or compute a value for one or more (or each) demographic persona variable for the target virtual persona. In some such embodiments, the generated or computed values may be restricted to values or value ranges included in or defined by the community persona template. In some such embodiments, the generated or computed values for each persona variable may be generated or computed based on a persona variable distribution corresponding to each persona variable. As a non-limiting example, for each generated virtual persona, the persona generation model may generate or compute an age, a gender, a country of birth, and/or any other demographic persona variable values.

In some embodiments, the one or more persona generation stages may include an emotional and intellectual feature generation stage. In such embodiments, the virtual persona generation model may generate or compute a value for one or more (or each) emotional or intellectual persona variable for the target virtual persona. In some such embodiments, the generated or computed values may be restricted to values or value ranges included in or defined by the community persona template. In some such embodiments, the generated or computed values for each persona variable may be generated or computed based on a persona variable distribution corresponding to each persona variable. As a non-limiting example, for each generated virtual persona, the persona generation model may generate or compute an IQ score, an EQ score, and/or any other emotional or intellectual persona variable values.

In some embodiments, the one or more persona generation stages may include a personality core trait generation stage. In such embodiments, the virtual persona generation model may generate or compute a value for one or more (or each) personality or personality trait persona variable for the target virtual persona. In some such embodiments, the generated or computed values may define and/or characterize a psychological profile of the target virtual persona. In some such embodiments, the generated or computed values may be restricted to values or value ranges included in or defined by the community persona template. In some such embodiments, the generated or computed values for each persona variable may be generated or computed based on a persona variable distribution corresponding to each persona variable. As a non-limiting example, for each generated virtual persona, the persona generation model may generate or compute one or more five-factor personality trait values, a personality type value (e.g., a Myers-Briggs Type Indicator), and/or any other personality or psychological persona variable values.

In some embodiments, the one or more persona generation stages may include a psychological factor generation stage. In such embodiments, the virtual persona generation model may generate or compute a value for one or more (or each) psychological factor persona variable for the target virtual persona. In some such embodiments, the generated or computed values may be restricted to values or value ranges included in or defined by the community persona template. In some such embodiments, the generated or computed values for each persona variable may be generated or computed based on a persona variable distribution corresponding to each persona variable. As a non-limiting example, for each generated virtual persona, the persona generation model may generate or compute one or more positive and negative personality traits, primary motivators, fears, insecurities, and/or any other psychological factor persona variable values.

In some embodiments, the one or more persona generation stages may include a virtual life progression generation stage. In such embodiments, the virtual persona generation model may generate or compute a value for one or more (or each) virtual life progression persona variable for the target virtual persona. In some such embodiments, the generated or computed values may be restricted to values or value ranges included in or defined by the community persona template. In some such embodiments, the generated or computed values for each persona variable may be generated or computed based on a persona variable distribution corresponding to each persona variable. Additionally, in some embodiments, the virtual persona generation model may generate or compute one or more virtual life progression attributes for each virtual persona. A virtual life progression attribute, as generally referred to herein, may relate to any attribute or aspect of a virtual persona that may characterize a virtual or simulated life path of a virtual persona. As a non-limiting example, the persona generation model may generate or compute the education, occupation, relationship(s), social and consumer behavior, and past social experiences, and/or any other virtual life progression attribute or persona variable values for each generated virtual persona.

In some embodiments, the one or more persona generation stages may include a virtual life event generation stage. In such embodiments, the virtual persona generation model may generate or compute a value for one or more (or each) virtual life event persona variable for the target virtual persona. In some such embodiments, the generated or computed values may be restricted to values or value ranges included in or defined by the community persona template. In some such embodiments, the generated or computed values for each persona variable may be generated or computed based on a persona variable distribution corresponding to each persona variable. Additionally, in some embodiments, the virtual persona generation model may generate or compute one or more virtual life event attributes for each virtual persona. A virtual life event attribute, as generally referred to herein, may relate to any attribute or aspect of a virtual persona that may characterize a virtual or simulated life event of a virtual persona. In some embodiments, virtual life event attributes may function to further diversify and differentiate distinct virtual personas.

In some embodiments, the virtual persona generation model may execute the one or more persona generation stages sequentially. As a non-limiting example, for each generated virtual persona, the virtual persona generation model may execute, in sequence, a demographic generation stage, an emotional and intellectual feature generation stage, a personality core trait generation stage, a psychological factor generation stage, a virtual life progression stage, and a virtual life event generation stage. It shall be noted that the above example is non-limiting, and the virtual persona generation model may function to execute the one or more persona generation stages in other sequences or orders, and/or may function to include one or more additional or alternative suitable persona generation stages.

In some embodiments, for each generated virtual persona, each persona generation stage may include or be based on the generated values, attributes, and/or features of previously executed stages. In such embodiments, for each virtual persona, the virtual persona generation model may function to generate or compute values, attributes, features, and/or the like at each persona generation stage that may be consistent with and/or coherent with all values, attributes, features, and/or the like generated during previous persona generation stage(s). In some such embodiments, the virtual persona generation model may be configured to prioritize consistency between generated or computed values such that each computed value (e.g., each computed persona variable value) may not conflict with other previously computed values for a distinct generated virtual persona. In some preferred embodiments, internal consistency of computed values, attributes, features, and/or the like of each generated virtual persona may be initiated and/or enforced based on prompt engineering of inputs to the virtual persona generation model during each persona generation stage. Additionally, in one or more embodiments, the virtual persona generation model may include one or more large language models and/or the like that may leverage learned statistical patterns, associations, and correlations between human characteristics based on one or more diverse training corpora to generate virtual personas with internally consistent persona variable values, attributes, and features.

In some embodiments, once a batch of n personas has been generated, S230 may function to validate each generated persona of the batch of n personas. In such embodiments, validation of a generated persona may include determining if each generated persona includes all persona variables and only the correct, valid persona variable values for the persona variables. In some embodiments, once an incorrect persona variable value is identified, S230 may function to attempt to remediate the identified incorrect value. In some such embodiments, identified incorrect values may be remediated based on S230 executing (e.g., via the virtual persona generation model) fuzzy matching between the identified incorrect values and corresponding persona variable values from the virtual community persona template.

In one or more embodiments, S230 may function to identify generated personas with missing and/or invalid persona variable values as invalid virtual personas that may not be included in the virtual persona community. In some such embodiments, invalid virtual personas may be discarded or deleted. It shall be noted that, in some preferred embodiments, invalid virtual personas may not count toward the population of N virtual personas to be generated for the virtual persona community. That is, in some preferred embodiments, the number N of virtual personas in the virtual persona community may represent a number N of valid virtual personas. In some such embodiments, S230 may function to generate a virtual persona to replace each generated invalid virtual personas, such that a final number of generated personas for the virtual persona community is equal to N. In some embodiments, if a batch of n generated personas includes a number q of invalid personas, where q is greater than zero, the batch of generated personas may include less than a number n of valid generated virtual personas (e.g., n-q valid generated virtual personas).

In some embodiments, for each distinct virtual persona (or valid persona) in a generated batch of personas, once all persona generation stages have been completed (e.g., all persona variables have been given values for the target distinct virtual persona), the virtual persona generation model may function to output a virtual persona artifact corresponding to the generated target distinct virtual persona. The virtual persona artifact may include the generated or computed values from each of the persona generation stages for the target distinct virtual persona. In some embodiments, each batch of personas may be generated sequentially (i.e., each persona of the batch of personas may be generated in a sequence). Alternatively, in some embodiments, each batch of personas may be generated in parallel (i.e., each persona of the batch of personas may be generated concurrently).

In some preferred embodiments, once a batch of personas has been generated, S230 may function to compute empirical marginal distributions p⁽ⁱ⁾_{community} across all persona variables from all generated virtual personas of the target virtual persona community, where persona variables are indexed by i. In such preferred embodiments, S230 may function to compare each empirical marginal distribution for each persona variable with a respective target distribution p⁽ⁱ⁾ₜₑₘₚₗₐₜₑ from the virtual community persona template. In such embodiments, S230 may function to compute a marginal distribution difference, Δ⁽ⁱ⁾=p⁽ⁱ⁾ₜₑₘₚₗₐₜₑ−p⁽ⁱ⁾_{community}, that may indicate, based on a threshold ∂, if the persona variable indexed at i is overrepresented or underrepresented at a current stage of the virtual community generation process.

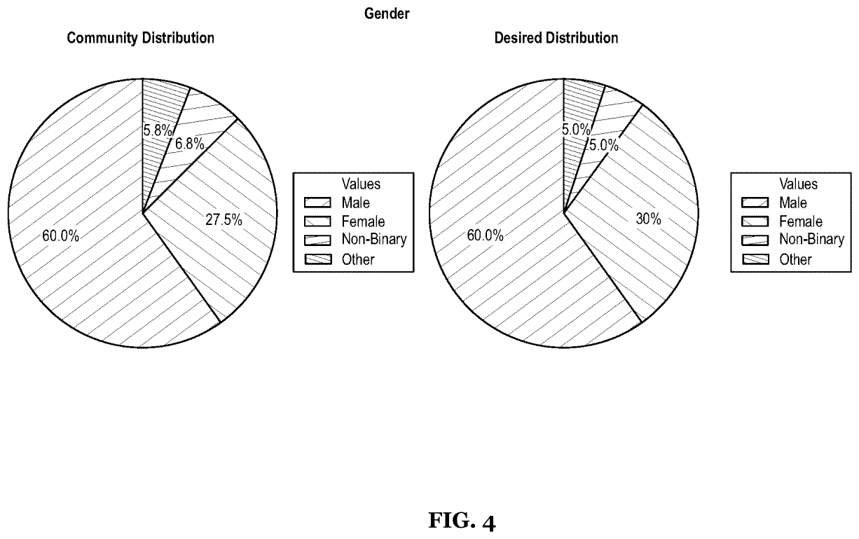

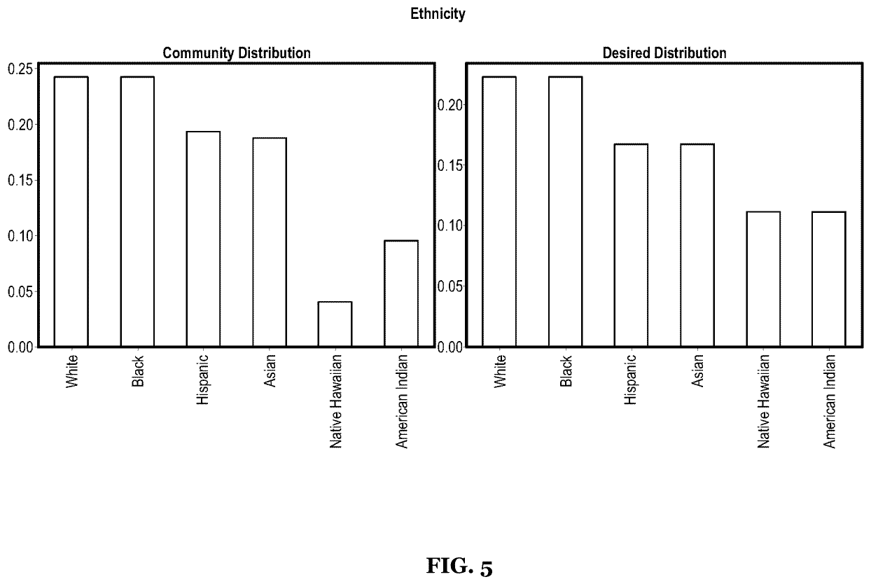

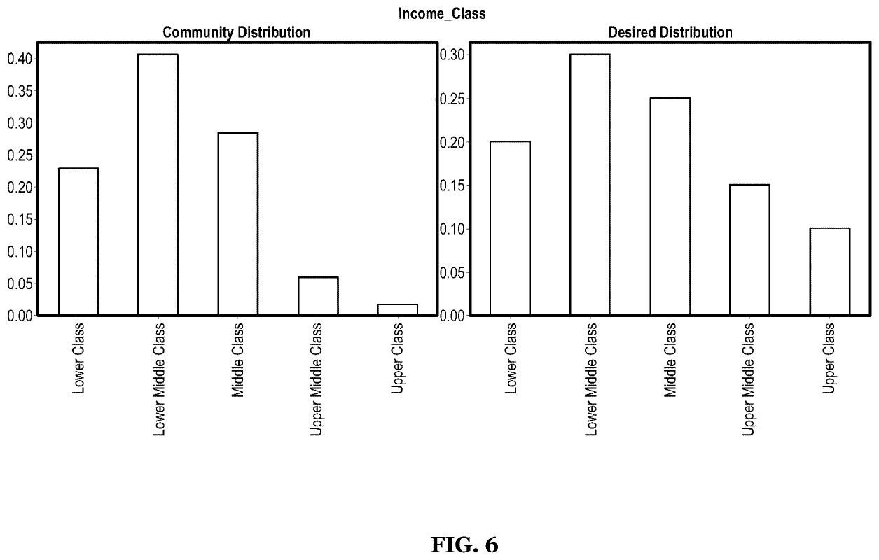

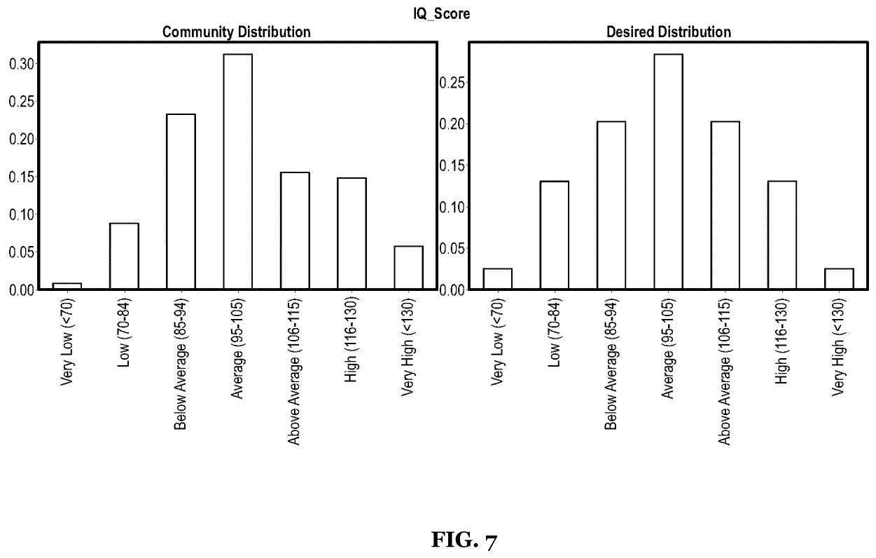

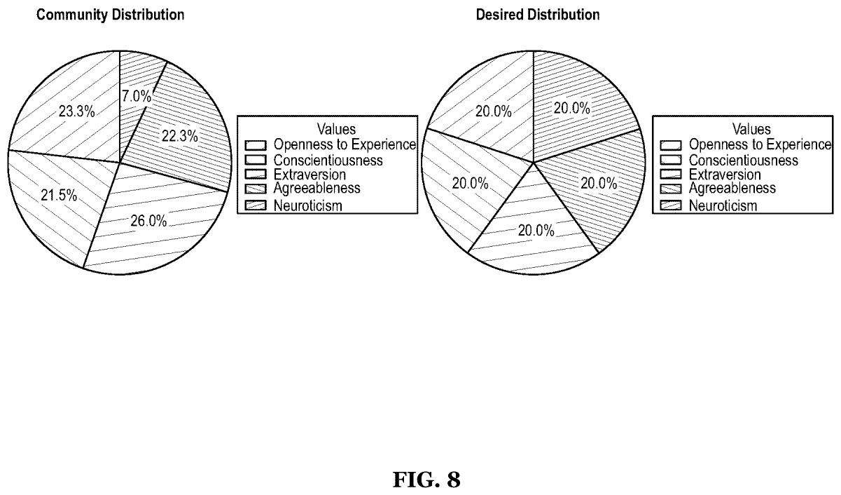

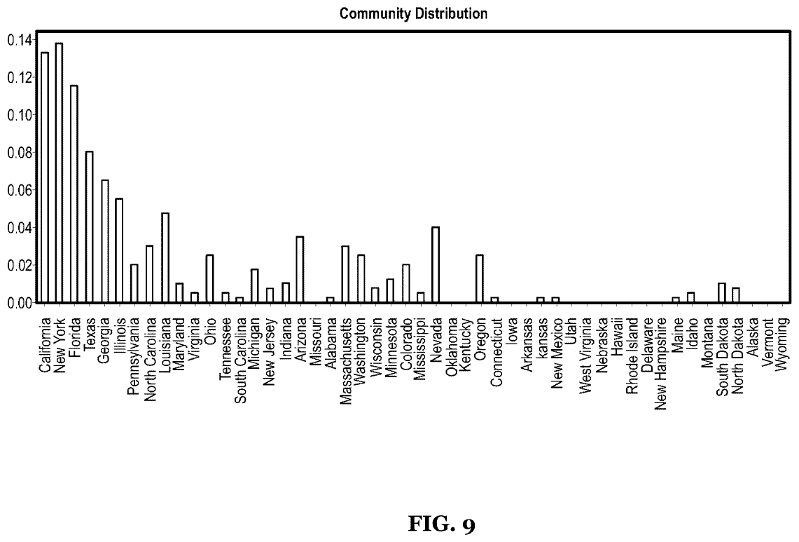

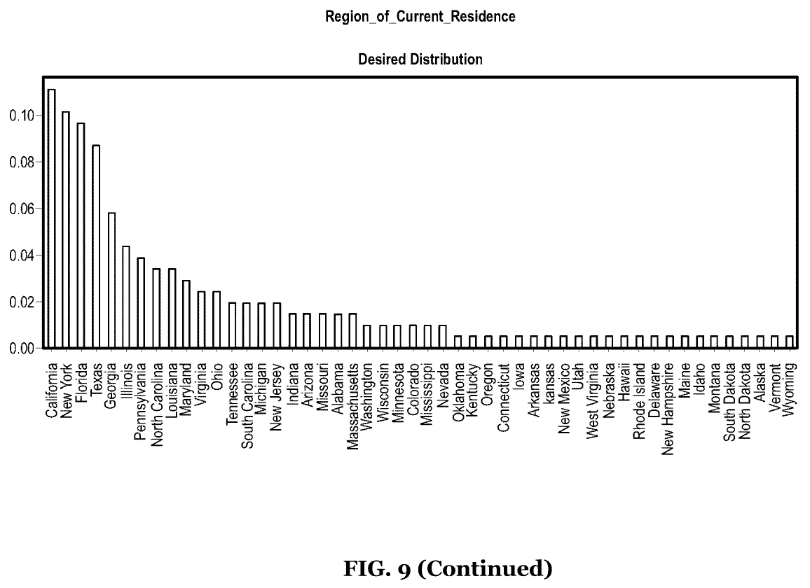

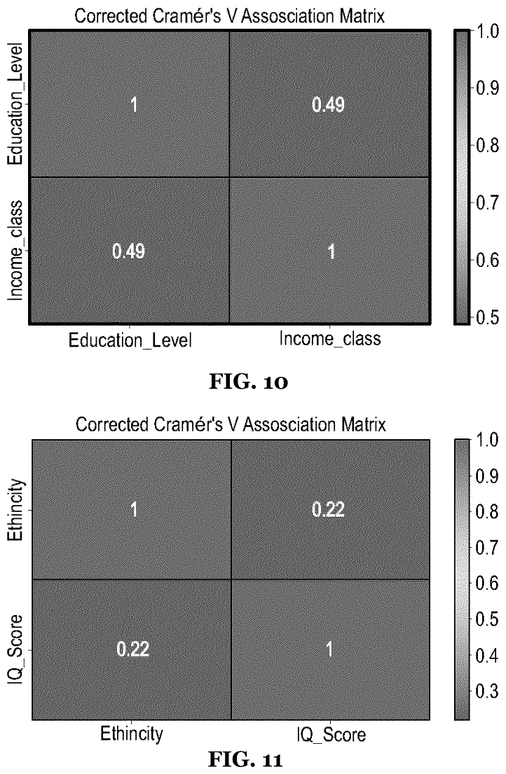

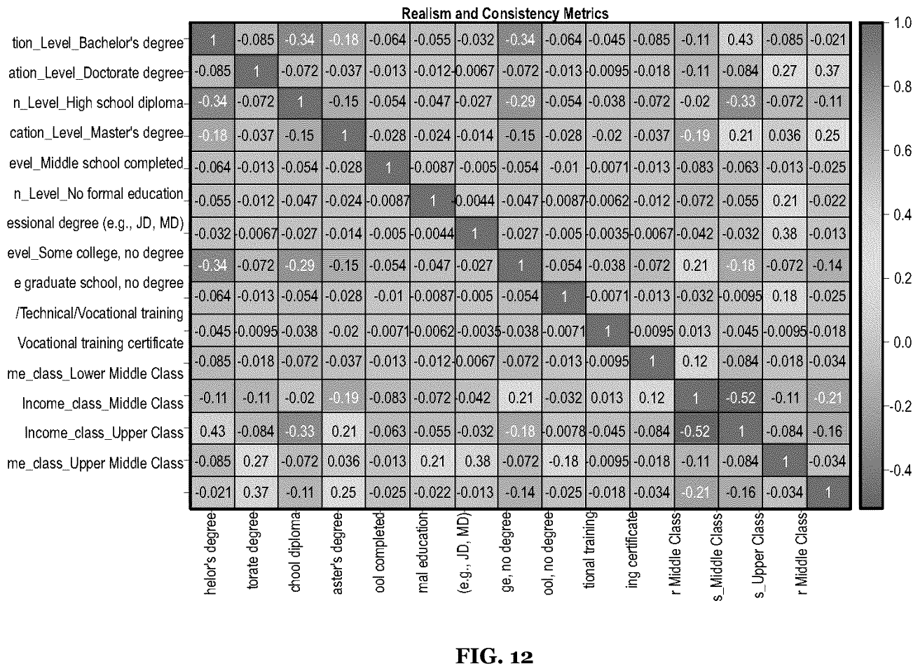

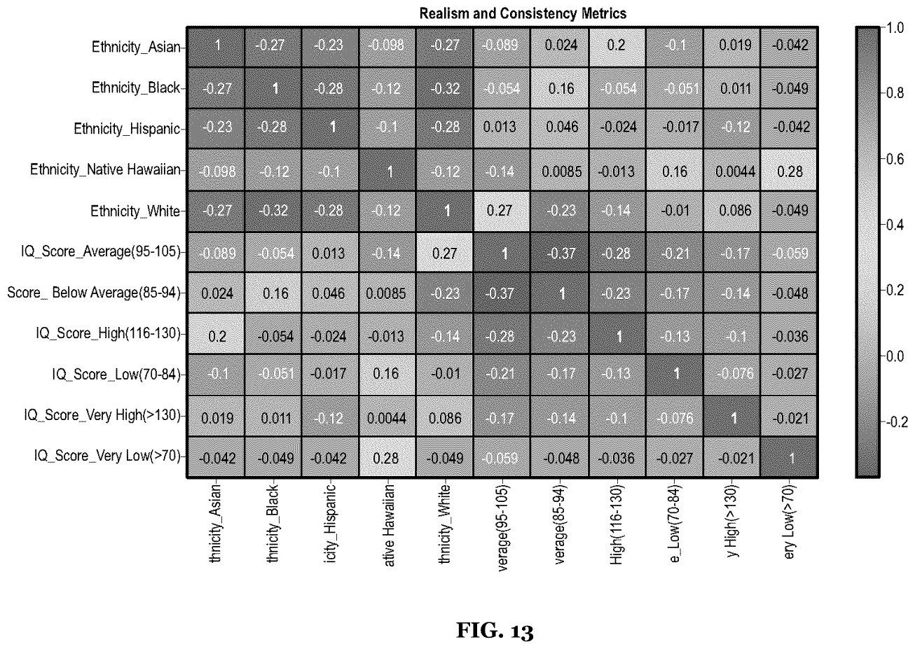

In some embodiments, S230 may function to output the empirical marginal distribution, the target distribution (i.e., the persona variable distribution defined in the virtual community persona template), and/or the marginal distribution difference for one or more (or each) community persona variable after each batch generation iteration via the virtual community generation user interface, such that a user or subscriber may monitor the persona variables and persona variable distributions of the target virtual community in real-time as batches of virtual personas are generated for the target virtual community. In some such embodiments, S230 may function to construct one or more distribution comparison visualization objects that may function to display the empirical marginal distribution, the target distribution, and/or the marginal distribution for one or more persona variables, and/or one or more correlations between one or more persona variables, in the virtual community generation user interface, as shown by way of example in FIGS. 4-13. In various embodiments, the distribution comparison visualization objects may include, but are not limited to, one or more bar charts, pie charts, histograms, Cramer's V graphical display objects, data tables, correlation matrices, and/or any other suitable data visualization object for displaying the empirical marginal distribution, the target distribution, and/or the marginal distribution for one or more persona variables, and/or one or more correlations between one or more persona variables.

In some preferred embodiments, once a batch of personas has been generated, S230 may function to evaluate whether the number of (valid) virtual personas that have been generated for the target virtual community is less than to N (i.e., less than the total number of virtual personas to be generated for the target virtual persona community). In some such embodiments, if the number of (valid) virtual personas that have been generated is less than N, S230 may function to initiate a subsequent batch generation iteration for a subsequent batch of n personas. In some preferred embodiments, for each subsequent batch generation iteration, S230 may function to configure the virtual persona generation model to preferentially select or promote persona variable values that may be underrepresented based on the marginal distribution difference for each persona variable, and to suppress or avoid persona variable values that may be overrepresented based on the marginal distribution difference for each persona variable. Accordingly, in such embodiments, the use of marginal distribution differences for each persona variable in the generation of subsequent batches of virtual personas may be iteratively controlled or guided and may provide the technical benefit of improving a correlation between the persona variable distributions of the target virtual persona community and the corresponding variable distributions of a real-world target community of individuals.

In some embodiments, once all N (valid) virtual personas have been generated, S230 may additionally function to generate one or more pieces of virtual community augmenting data or metadata for each virtual persona. In such embodiments, this may preferably enable each of the generated virtual personas of the target virtual community to be associated with one or more pieces of virtual community augmenting data (as described in 2.1). In some such embodiments, each virtual persona artifact may include a persona variable with a variable value that may correspond to one or more assets or pieces of virtual community augmenting data.

In some embodiments, the virtual persona generation model may include a virtual persona image generation model that may function to generate an image based on an input of one or more generated virtual personas or virtual persona artifacts. In some such embodiments, the virtual persona image generation model may include a text-to-image model (e.g., a diffusion model or the like). In some such embodiments, after generating each virtual persona (e.g., after generating a virtual persona in a batch of n virtual personas), the virtual persona image generation model may function to generate an image for each virtual persona that may represent a likely or plausible appearance of the corresponding virtual persona. Additionally, or alternatively, once all N (valid) virtual personas of a virtual community have been generated, the virtual persona image generation model may generate a virtual community image for the virtual community that may represent a likely or plausible appearance for an average virtual persona in the virtual community.

S230 may determine, using one or more processors and after obtaining a first batch of the set of batches, a difference between the first distribution of values associated with the first batch for a community persona variable and the target distribution of values identified for that variable. This determination process may involve comparing the empirical distribution of a specific variable within the generated batch of virtual personas, such as age or income, against the predefined distribution established in the virtual community persona template. For example, if the template specifies an age distribution skewed toward younger demographics, but the first batch predominantly includes older personas, S230 may identify this discrepancy as a distribution difference. Statistical methods, such as divergence metrics (e.g., Kullback-Leibler divergence) or distribution comparison techniques, may be employed to quantify the difference, ensuring identification of misalignments in the variable's representation.

Upon determining the difference, S230 may update, using one or more processors, a prompt of the set of persona-generating prompts associated with the community persona variable. This update process may involve modifying the instructions or constraints within the prompt to guide the language learning models toward generating values that better align with the target distribution. For instance, if the variable “age” exhibits an overrepresentation of older personas, the prompt may be adjusted to prioritize generating younger age values within the specified range or distribution. Updates to the prompt may include explicit constraints, refined sampling strategies, or adjusted weights for underrepresented values. These modifications ensure that the second batch of virtual personas more accurately reflects the distributions defined in the template, aligning the generated personas with the target demographic or psychographic goals.

Using the updated prompt, S230 may generate a second batch of virtual personas, ensuring that the adjustments made to the prompt address the previously identified distribution differences. The updated prompt guides the language learning models to produce virtual personas whose variable values more closely align with the intended distributions for the community persona variable. This iterative feedback and adjustment mechanism enables S230 to refine persona generation dynamically, improving the statistical fidelity and representational accuracy of the virtual persona community over successive iterations. By reconciling empirical outputs with predefined targets, S230 maintains coherence and consistency. In a non-limiting example, as described with reference to FIG. 3, performing the generation of batches according to distribution differences may occur at 315 as described with reference to FIG. 3.

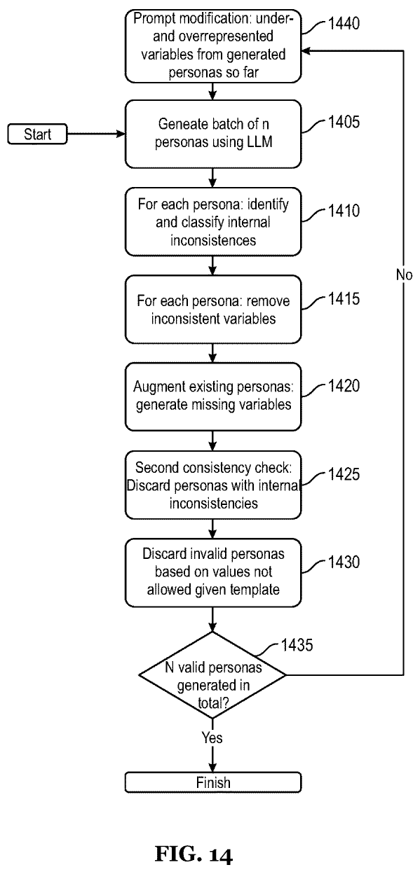

In some examples, the first and second batches may be included in a set of batches obtained in an iterative sequence. For instance, in a non-limiting example as depicted in FIG. 14, a first batch of an iterative sequence may be generated at 1405. If the system (e.g., a virtual persona service) proceeds to 1440 after generating the first batch, a second batch of the iterative sequence may be obtained. Additional batches may be obtained for the iterative sequence each time the system visits 1440.

S230 may iterate through the set of batches. For instance, S230 may update the first distribution of values based on obtaining the second batch; may determine, after obtaining the second batch, an updated difference between the updated first distribution of values and the distribution of values identified for the community persona variable; and may update the prompt of the set of prompts associated with the community persona variable based on the updated difference, where a subsequent batch in the sequence is obtained based on the updated prompt. These steps may be repeated for each batch of the set of batches subsequent to the second batch in an order defined by the iterative sequence, where these steps may be repeated until a total quantity of samples associated with the obtained batches exceeds a threshold amount. In a non-limiting example, as described with reference to FIG. 14, after the second batch is obtained at 1405, the system may proceed to 1435. At 1435, the system may determine that a total quantity of samples associated with the first batch and the second batch is less than N. Accordingly, the system may proceed to 1440. At 1440, the system may update an actual distribution of values associated with the first batch and the second batch for a community persona variable (e.g., a distribution aggregated from all previously generated batches) and may determine a difference between the actual distribution of values and a target distribution for the community persona variable. The system may then update a prompt corresponding to the community persona variable and may proceed to 1405 to obtain a subsequent batch. After obtaining the subsequent batch, the system may proceed to 1435 and determine if the first batch, second batch, and subsequent batch have a total quantity of samples less than N. If so, the system may proceed to 1440. At 1440, the system may update an actual distribution of values associated with the first batch, the second batch, and the subsequent batch and may determine a difference between the actual distribution values and the target distribution. The system may then update the prompt and may proceed to 1405 to obtain the next batch. This process may repeat until the obtained batches cumulatively have more than N valid samples.

S230 may split, using one or more processors, a video asset into a sequence of discrete video chunks. This process segments the video into manageable units, each representing a predefined time interval or a logically distinct segment, such as a scene or activity. For example, a 10-minute video might be split into 30-second chunks or segments delineated by scene transitions. Splitting the video into chunks ensures efficient processing and analysis by enabling parallel extraction of information from each segment. The segmentation may be achieved through techniques such as time-based slicing, scene change detection, or audio-visual content analysis.

After splitting the video asset, S230 may extract, using one or more processors, video information from each video chunk. The extracted information may include (1) a respective audio transcript generated by applying speech-to-text algorithms to the audio content of the chunk, (2) an interpretation of one or more activities occurring within the chunk based on computer vision or audio analysis, and (3) a set of representative frames sampled from the chunk. For instance, S230 may analyze a video chunk to produce an audio transcript detailing spoken dialogue, detect activities such as “walking” or “interacting with an object,” and capture key frames that visually represent the chunk's content. Advanced machine learning models, including natural language processing and computer vision algorithms, may be employed to extract this information with high accuracy and contextual relevance.

S230 may link, using one or more processors, one or more virtual personas from the virtual persona community with an identifier of the video asset. This linking establishes an association between the video asset and specific personas whose attributes or roles align with the video's content. For example, if the video depicts a product tutorial, virtual personas representing the target audience for the product may be linked to the video. The linkage process may use metadata, such as the video's topic, context, or intended audience, to match relevant personas. This association enables the personas to respond or engage with the video content in a manner that reflects their defined demographic and psychographic profiles.

Using the extracted video information and the linkage between the video asset and virtual personas, S230 may generate, using one or more processors, one or more responses based on the extracted video information and/or the linkage. These responses may reflect the perspectives, insights, or reactions of the linked virtual personas to the video content. For example, based on the audio transcript, identified activities, and representative frames, a persona may respond with comments such as “The instructions in the video are clear, but I would prefer more visual examples.” The responses may leverage both the extracted video details and the persona-specific attributes, such as age, occupation, or cultural background, ensuring that the interactions are contextually relevant and personalized.

In a non-limiting example, as described with reference to FIG. 3, at 340, a system (e.g., a virtual persona service) may perform knowledge base creation. To perform knowledge base creation, the system may provide a video asset to inference endpoint 320B and inference endpoint 320B may extract video information for each video chunk from the video asset, where the video information may include, for each video chunk, a respective audio transcript, a respective description of activities occurring within the video chunk, and a respective set of associated frames. Inference endpoint 320B may return the video information to 340. Once the video information is received, the system, at 340, may update virtual personas at storage service 360 with an identifier of the asset (e.g., virtual personas most closely linked to a content of the video asset) and may additionally upload one or more knowledge bases to database 365. The information provided to storage service 360 and/or database 365 may be used to generate responses from the virtual persona community.

In some examples, S230 may generate, using one or more processors, a respective profile for each virtual persona within the virtual persona community. Each profile may include a unique identifier for the virtual persona and an indication of values for each community persona variable from the set of community persona variables. These variables may encompass demographic, psychographic, and behavioral attributes, such as age, gender, geographic location, occupation, personality traits, and preferences. For example, a virtual persona profile might include an identifier such as “Persona_001” along with attribute values {Age: 35, Gender: Female, Occupation: Engineer, Personality: Analytical}.

S230 may also generate, using one or more processors, a profile for the virtual persona community. This community profile may include a unique identifier for the community and a comprehensive list of the virtual personas within the community. The list may reference the unique identifiers of each persona, creating a structured representation of the entire community. For example, a community profile might include an identifier such as “Community_001” and a list of personas {Persona_001, Persona_002, Persona_003, . . . }. Additionally, S230 may provide, using one or more processors, the respective profiles for each virtual persona and the profile for the virtual persona community to a storage service. The storage service may be implemented as a cloud-based or on-premise database, ensuring secure and scalable storage of the profiles. In a non-limiting example, as illustrated with reference to FIG. 3, a system (e.g., a virtual persona service) may provide generated profiles for the virtual personas and the virtual personas community to storage service 360 upon generating the associated virtual personas and virtual persona community (e.g., at 315).

In some examples, S230 may synchronize, using one or more processors, the respective profile for each virtual persona with a database distinct from the primary storage service. This synchronization ensures that the profiles stored in the database remain consistent with those within the storage service. The synchronization process may involve transferring or updating data in real-time or at scheduled intervals. For example, if a virtual persona's profile in the storage service is updated to include a new attribute, such as a recently inferred personality trait or updated geographic location, S230 may propagate this change to the distinct database to maintain data parity.

The distinct database may be optimized for specific use cases, such as high-speed querying, analytics, or integration with external applications. For instance, while the storage service may function as the primary repository for persona data, the distinct database may support analytics workflows, enabling faster retrieval of aggregated insights across the virtual persona community. Synchronization processes may employ mechanisms such as incremental updates, conflict resolution protocols, and data validation to ensure accuracy and consistency between the two systems. In a non-limiting example, as illustrated with reference to FIG. 3, a system (e.g., a virtual persona service), at 345, may download information (e.g., a list of virtual personas and their corresponding profiles) from storage service 360. The system, at 345, may upload the downloaded information to database 365.

S230 may generate, using one or more processors and after performing the synchronization, reinforcement learning metadata for each virtual persona within the virtual persona community. The metadata may include metrics, such as persona response accuracy, consistency with predefined community persona variables, engagement quality, and sentiment appropriateness during interactions. For example, reinforcement learning metadata for a persona might record performance indicators such as “response coherence: 95%” or “alignment with demographic traits: 90%.” These metrics may be derived from analyses of persona interactions with users, their responses to simulated scenarios, or evaluations of their generated attributes.

S230 may tune, using one or more processors, the one or more language learning models based at least in part on the generated reinforcement learning metadata. The tuning process may involve adjusting model parameters, fine-tuning specific aspects of the model's behavior, or updating training data to address deficiencies identified through the metadata. For instance, if a persona consistently generates responses that deviate from its intended demographic or psychographic profile, the reinforcement learning metadata may highlight these deviations, prompting the model to reweight or prioritize certain input features during training. Advanced reinforcement learning techniques, such as reward functions or gradient-based optimization, may be applied to align the model's output with the desired persona attributes and behaviors. In a non-limiting example, as depicted with reference to FIG. 3, a system (e.g., a virtual persona service) may generate reinforcement learning data for the generated virtual personas at 350 and may provide the metadata to database 365. Once the metadata has been added at 350, the system may add a new virtual persona community to a frontend of the application (e.g., to a user interface).

In some examples, S230 may call, using one or more processors, an inference endpoint to generate a respective profile image for each virtual persona within the virtual persona community and a profile image representing the virtual persona community as a whole. The inference endpoint may be an external or integrated service, such as a generative image model (e.g., a text-to-image diffusion model or GAN-based model), capable of producing visually realistic and contextually appropriate images. Each profile image for the virtual personas may be generated based on the unique attributes and community persona variables defined in their respective profiles. For instance, a virtual persona described as a middle-aged professional might have a profile image that visually reflects traits such as age, gender, and cultural background. Similarly, the profile image for the virtual persona community may be an aggregated or symbolic representation of the group, reflecting shared characteristics or a composite visualization of the personas.

S230 may receive, using one or more processors, the respective profile image for each virtual persona and the profile image for the virtual persona community from the inference endpoint. These images may be transmitted in formats suitable for storage and display, such as PNG or JPEG, and may include metadata linking them to their respective personas or the overall community profile. For example, the image for a virtual persona might be tagged with the persona's unique identifier, while the community profile image may include identifiers for all personas it represents. The received images are validated to ensure quality and alignment with the specified persona characteristics before further processing.

S230 may store, using one or more processors, the respective profile image for each virtual persona and the profile image for the virtual persona community at a designated storage service. This storage service may be cloud-based or on-premises, providing secure and scalable management of image assets.

S230 may output, using one or more processors and via the user interface, the respective profile image for each virtual persona and the profile image for the virtual persona community. The user interface may present these images in a visually organized format, enabling users to view, explore, and interact with the personas and their community. For instance, the interface might display a gallery of persona images with accompanying demographic and psychographic details or showcase the community profile image as a symbolic representation of the group.

In a non-limiting example, as described with reference to FIG. 3, after a system (e.g., a virtual persona service) generates a virtual persona community, the system at 330 may identify an image for each virtual persona of the virtual persona community. For instance, the system may call inference endpoint 320A to generate an image for each virtual persona of the virtual persona community, where inference endpoint 320A may return the requested images after the request. Upon receiving the virtual persona images, the system, at 330, may upload the images to storage service 360, where each image may be linked to a respective virtual persona. Additionally, at 335, the system may identify an image for the virtual persona community. For instance, the system may call inference endpoint 320A to generate an image for the virtual persona community, where inference point 320A may return the requested image after the request. Upon receiving the virtual persona community image, the system at 335 may provide the virtual persona community image to storage service 360, where the virtual persona community image may be linked to the virtual persona community.

### Consistency Checking

A quality level of an interaction with a virtual persona may depend on the internal consistency of the persona's attributes. While the persona generation process attempts to balance internal consistency with alignment to the target audience's variable distributions, perfectly consistent personas may not be guaranteed in a single generation step. This limitation may arise due to persona generation occurring in a probabilistic manner and, accordingly, may be susceptible to errors inherent in the model's outputs. Such errors may manifest as inconsistencies within the attributes of individual personas.

S230 may classify inconsistencies into three levels based on severity: contradictions, highly implausible attributes, and unlikely attributes. Contradictions refer to logical conflicts between persona variables that cannot coexist (e.g., a persona with a region of birth listed as France but a country of birth listed as India, or a persona classified as a non-smoker while simultaneously exhibiting smoking-related behaviors). Highly implausible inconsistencies involve combinations that, while technically possible, are extremely unlikely to occur in reality (e.g., a persona with an extremely low age serving as a successful CEO). Unlikely inconsistencies represent rare combinations statistically improbable within small sample sizes (e.g., a persona who is both an Olympic athlete and holds a PhD in physics). These classifications enable targeted remediation of inconsistent personas to enhance realism and reliability.

To mitigate inconsistencies, S230 may perform consistency checking as part of the persona generation process. After a batch of personas is generated, S230 may evaluate each persona by analyzing its attributes and identifying inconsistencies based on predefined rules and severity classifications. In one or more examples, S230, implemented using a large language model (LLM) or similar reasoning-based system, may process all attributes of a persona to detect inconsistencies. For inconsistencies classified as contradictions or highly implausible attributes, S230 may remove the affected variables from the persona profile.

For instance, S230 may apply, using one or more processors, a variable value consistency assessment (e.g., a consistency check) to each virtual persona generated by the one or more language learning models for a batch of the one or more batches. This assessment may function to evaluate the internal coherence and statistical alignment of the community persona variables associated with each virtual persona. For instance, S230 may analyze variables such as age, occupation, and education level to identify inconsistencies, such as a persona described as a high school student but simultaneously possessing an advanced degree. The assessment may also detect logical contradictions (e.g., a persona categorized as a non-smoker while displaying smoking-related behaviors) and statistical anomalies that deviate significantly from the distributions defined in the virtual community persona template. By leveraging machine learning models and predefined validation rules, S230 systematically identifies a subset of personas exhibiting these inconsistencies for further remediation.

Upon identifying a subset of virtual personas with attribute inconsistencies, logical contradictions, or statistical anomalies, S230 may update, using one or more processors, each virtual persona in the subset. The updating process may involve generating updated values for the affected community persona variables to resolve inconsistencies and ensure alignment with the persona template (e.g., via persona augmentation). For example, S230 may replace conflicting or implausible attributes with regenerated values derived from large language models or probabilistic distributions. A persona identified as both “retired” and “age: 25” may be corrected by modifying the retirement status or adjusting the age variable. This process may involve iterative feedback between the consistency-checking modules and the persona generation engine to refine the generated values dynamically. The updated personas are validated to ensure the resolutions maintain logical coherence and statistical fidelity, producing a set of corrected personas suitable for inclusion in the complete virtual persona community.

Following persona augmentation, S230 may apply a second consistency check to validate the updated personas. During this validation phase, S230 may analyze each persona for any remaining inconsistencies, such as logical contradictions. If a persona still exhibits contradictions after augmentation, it may be declared invalid and discarded. This step ensures that only logically coherent and contextually appropriate personas are retained in the virtual persona community. For example, a persona with irreconcilable conflicts, such as “age: 12” and “occupation: CEO,” may be removed to preserve the integrity of the community.

For instance, S230 may apply, using one or more processors, a second variable value consistency assessment to each of the updated virtual personas. This assessment may evaluate the logical coherence and internal consistency of community persona variables within the updated personas. The second assessment may focus on identifying remaining logical contradictions that were not resolved during the initial updating process. For example, a persona with conflicting attributes such as being classified as “unemployed” while simultaneously holding an “executive” occupational role may be flagged. The assessment may utilize predefined logical rules, statistical thresholds, or reasoning-based models, such as large language models (LLMs), to ensure that all persona attributes align with the intended demographic and psychographic distributions. By systematically analyzing each updated persona, the second consistency assessment may ensure that any unresolved inconsistencies are identified for remediation or removal.

For each updated virtual persona identified as having one or more unresolved logical contradictions, S230 may discard, using one or more processors, the persona from the batch. This step ensures that only valid and logically consistent personas are retained within the virtual persona community. Discarded personas may be excluded from further processing, thereby preserving the integrity and statistical alignment of the final community. For instance, a persona identified with irreconcilable attributes such as “age: 12” and “occupation: CEO” would be removed to maintain credibility and coherence in the generated personas. This discarding process eliminates anomalies that could compromise the reliability of the virtual persona community in downstream applications, such as market analysis, user experience testing, or simulation-based research. By enforcing quality control through the second consistency assessment and persona removal, S230 ensures that the generated persona community adheres to greater contextual accuracy.

FIG. 14 may depict an example of an algorithmic flow chart representing steps performed during persona generation (e.g., at 315 of FIG. 3 and/or by persona generation engine 130 of FIG. 1) by a system (e.g., a virtual persona service). At 1405, a batch of n personas may be generated, where n may be an integer greater than or equal to 1. At 1410, the system may identify and classify internal inconsistencies for each virtual persona of the n personas within the batch generated at 1405. At 1415, the system may remove inconsistent community persona variables (e.g., those associated with the internal inconsistencies). At 1420, the system may augment existing virtual personas (e.g., via persona augmentation as described herein) to generate missing variables (e.g., those that were removed at 1415). At 1425, the system may perform a second consistency check and may discard any virtual personas from the batch associated with internal inconsistencies. Additionally, at 1430, the system may discard invalid personas based on values restricted by the community persona template.

At 1435, the system may determine if N non-discarded virtual personas have been generated. If so, the system may finish persona generation. If not, the system may proceed to 1440. At 1440, the system may modify prompts provided to the LLM at 1405 to account for underrepresented and/or overrepresented variables from generated virtual personas previously generated. The system may then proceed to 1405, where the system may generate an additional n virtual personas based on the modified prompts.

One of ordinary skill in the art will appreciate that the techniques described herein provides technical advantages and practical applications over existing methods for generating virtual personas. For instance, other persona generation systems may produce personas with internal inconsistencies or logical contradictions that undermine their realism and utility. These systems may rely on static rules or limited validation processes, which may fail to address complex interdependencies between persona variables. The techniques described herein, however, utilize consistency checking to evaluate the logical coherence of persona attributes systematically and apply targeted remediation strategies. This capability ensures that generated personas maintain a high level of internal consistency, enhancing their reliability and making them suitable for diverse applications.

2.40 Constructing a Virtual Community Digital Artifact based on the Generated Virtual Persona Community

S240, which includes constructing a virtual community digital artifact based on the generated virtual persona community, may function to construct a virtual community digital artifact that may function to represent and enable one or more virtual or simulated interactions with the generated virtual persona community. A virtual community digital artifact, as generally referred to herein, may relate to a data structure (e.g., a data object or the like) that may include the virtual community generation parameters, persona variables, and virtual community descriptors of a corresponding virtual community. In some embodiments, the virtual community digital artifact may only include user-specified persona variables (i.e., the target characteristics collected by S210). Preferably, each virtual community digital artifact may additionally include a list of all generated (valid) virtual personas of the corresponding virtual community. In some embodiments, each entry in the list of generated virtual personas may include a hash (e.g., a SHA-256 hash) of each corresponding virtual persona artifact, such that each virtual persona of the corresponding virtual community may be identified by the hash of the corresponding virtual persona artifact.

As a non-limiting example, S240 may function to construct a virtual community digital artifact for a target virtual community by constructing a data object (e.g., a JSON file) that may include the name of the target virtual community, the description of the target virtual community, and the community persona variables of the target virtual community. Alternatively, in such an example, the virtual community digital artifact may only include the target characteristics (i.e., the subset of persona variables for which persona variable values and/or persona variable distributions may have been input or specified by the user). Additionally, in the above examples, S240 may function to compute a SHA-256 hash based on each virtual persona artifact of each generated virtual persona of the target virtual community, and in turn S240 may function to include a list of each computed hash in the virtual community digital artifact.

In some embodiments, S240 may be automatically initiated based on the generation of N virtual personas for the target virtual community; that is, in some embodiments, constructing the virtual community digital artifact may be triggered once all virtual personas for the target community have been generated. Alternatively, construction of the virtual community digital artifact may be initiated based on user/subscriber input.

In some preferred embodiments, for each generated virtual community, S240 may function to store the corresponding constructed virtual community digital artifact and/or each corresponding virtual persona artifact in a virtual community artifact repository. In some embodiments, the virtual community artifact repository may be a remote repository (e.g., remote server, cloud server, and/or the like). Alternatively, the virtual community artifact repository may be a local repository (e.g., a local server, local user device, and/or the like).

In some embodiments, S240 may additionally or alternatively function to enable one or more user queries to the virtual personas of a virtual community, as well as enable an output of one or more virtual persona responses to the one or more user queries. In such embodiments, each distinct virtual persona may be enabled to respond based on the corresponding persona variable values and generated attributes and characteristics of each distinct virtual persona. In some embodiments that may include virtual community augmenting data, the one or more virtual personas of a generated virtual community may respond to input user queries based on the virtual community augmenting data as well as the persona variable values and generated attributes and characteristics of each virtual persona.

In some embodiments, S240 may function to implement a virtual community interaction machine-learning model that may function to receive, as input, one or more user queries to the virtual personas of a target virtual community, one or more virtual persona artifacts of the virtual personas of the target virtual community, and the virtual community digital artifact of the target virtual community. In turn, in such embodiments, the virtual community interaction machine-learning model may function to compute or generate, as output, one or more likely or plausible responses to the one or more user queries from one or more virtual personas of the target virtual community. In some such embodiments, S240 may function to display, surface, or otherwise output the one or more likely or plausible responses to the one or more users via the virtual community generation user interface, and/or any other suitable user interface.

In some examples, S240 may receive, using one or more processors, a user query along with an indication of a specific virtual persona from the virtual persona community through an interactive user interface. The user query may represent a natural language input, such as a question or command, directed toward a selected virtual persona. The interactive user interface may present the virtual persona community visually, enabling users to browse, select, and interact with individual personas. For example, a user may select a persona representing a middle-aged professional from an urban area and submit a query such as, “What challenges do you face in balancing work and family life?” S240 may utilize this input to initiate a targeted interaction with the selected persona.

Upon receiving the user query and the indication of a virtual persona, S240 may construct, using one or more processors, a persona-describing prompt. The persona-describing prompt may be generated based on the respective distinct set of community persona variables and associated variable values corresponding to the indicated virtual persona. For instance, if the selected persona is defined by variables such as {Age: 40, Gender: Female, Occupation: Teacher, Geographic Location: Suburban}, the persona-describing prompt may embed this information to establish the context for the language learning model. This construction ensures that the response generated by S240 reflects the attributes, background, and perspective of the indicated persona, maintaining alignment with its defined characteristics.

S420 may additionally provide the user query and the constructed persona-describing prompt to one or more language learning models. The language learning models may utilize the persona-describing prompt to contextualize the user query within the framework of the selected persona's attributes and experiences. For example, the query “What are your thoughts on work-life balance?” may prompt the model to generate a response that reflects the challenges and perspectives of a teacher living in a suburban environment, as defined in the persona-describing prompt. By embedding the persona-specific context, S240 ensures that the response remains coherent and tailored to the persona's profile.

Additionally, S240 may output, using one or more processors, a response to the user query via the interactive user interface. The response, generated by the language learning models, may be presented in natural language, simulating a realistic interaction with the selected virtual persona. For instance, the response might include, “Balancing work and family life can be challenging, especially during the school year when my teaching schedule is hectic.” This output may enable users to engage with virtual personas in an interactive way. By integrating user queries, persona-describing prompts, and advanced language models, S240 may enable dynamic and contextually accurate persona interactions. In a non-limiting example, as described with reference to FIG. 3, after the system (e.g., a virtual persona service) provides virtual persona community to an application frontend, at 355, a user may provide queries to the system (e.g., via an interactive user interface). It should be noted that at least one of the one or more processors may be specially configured to perform tasks associated with S240.

### User Interface|Focus Group Discussion

Focus group discussions may be used to generate in-depth qualitative insights across various topics. By incorporating virtual personas, S240 may simulate focus group environments in which diverse personas, each defined by unique demographic and psychographic profiles, participate in a moderated discussion. Each persona may contribute opinions and share personal experiences, with dialogue aligning to their respective demographic and cultural backgrounds, thereby enhancing the realism and depth of the discussion.

Although the discussion environment may, in some examples, include the entire virtual persona community, participation may be restricted to a subset of personas selected for each question. This selective participation may be controlled by a behavioral algorithm which simulates the likelihood of engagement and willingness of each persona to respond based on the ongoing conversation. The behavioral algorithm may replicate real-world social dynamics by determining which personas are most likely to participate at specific moments, adding authenticity to the simulated interaction. The technical details of this behavioral selection mechanism are addressed in a separate report.

Insights from the simulated group chat discussions may be generated using a summarization task implemented by a large language model (LLM). The LLM may process the raw dialogue from the group chat to synthesize key themes, sentiment trends, and representative viewpoints into a concise and structured report. This automated approach may enable users to extract actionable insights from the simulated discussions without the need for manual review, thereby increasing efficiency and scalability. The combination of artificial personas, behavioral modeling, and advanced summarization techniques may allow researchers to achieve robust qualitative insights through simulated focus group discussions.

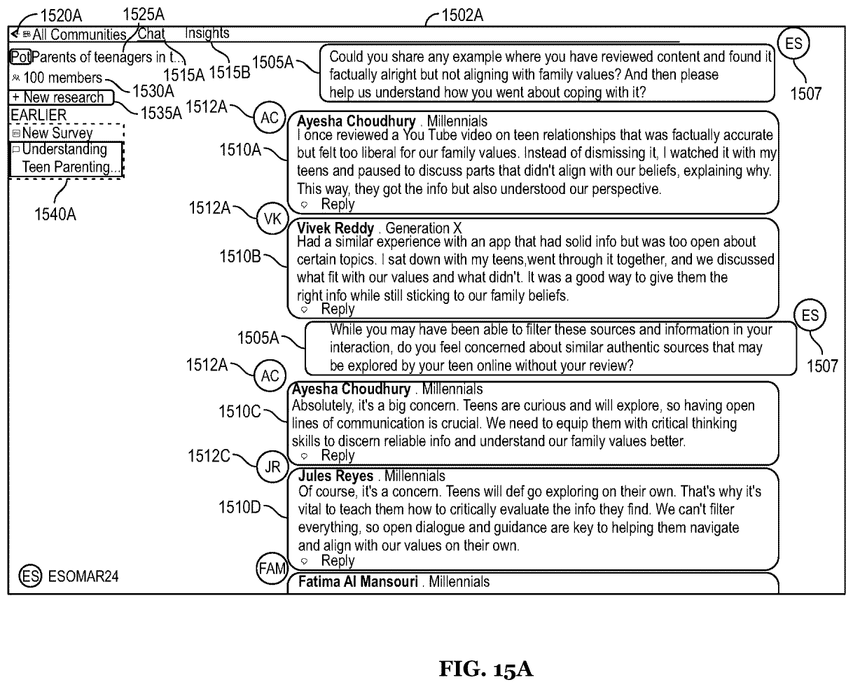

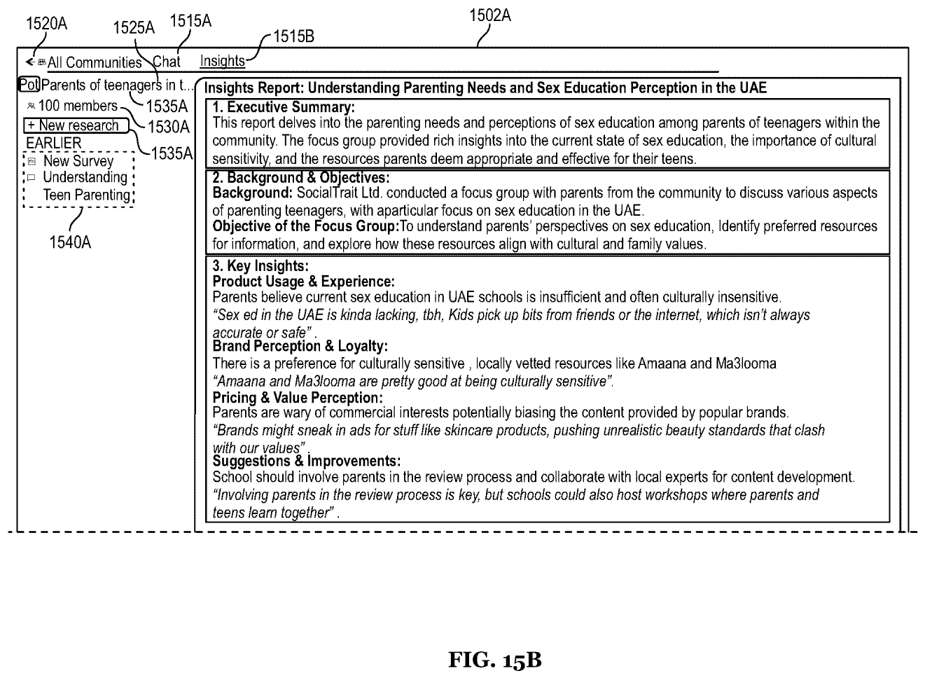

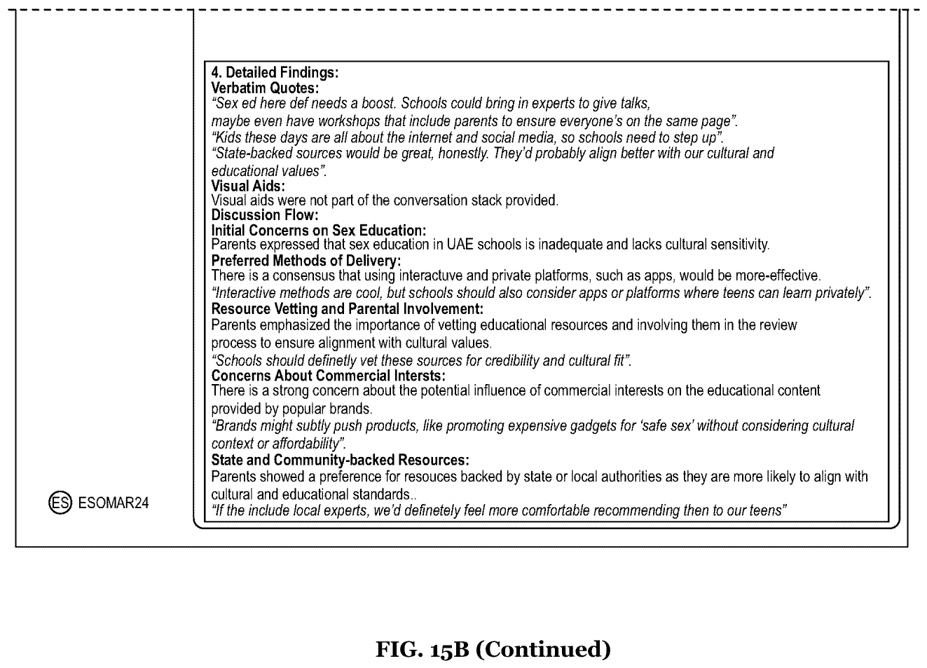

In a non-limiting example, FIGS. 15A and 15B may represent an example of an interactive user interface 1502A configured to simulate a group discussion with virtual personas of the virtual persona community. FIG. 15A may depict a first view of interactive user interface 1502A and FIG. 15B may depict a second view of interactive user interface 1502A. User interface 1502A may include a first user interface display element 1525A indicating a name of a virtual persona community and a second user interface display element 1530A indicating a number of virtual personas within the virtual persona community. Additionally, user interface 1502A may include a first user interface control element 1535A that may initiate a new survey simulation or a new group discussion simulation and a group 1540A of user interface control elements that may enable a user to interact and view other previously simulated surveys or group discussions. Additionally, user interface 1520A may include a second user interface control element 1520A that may enable a user to interact and view other previously generated virtual persona communities.

As depicted in FIGS. 15A and 15B, user interface 1502A may include tabs 1515A and 1515B. FIG. 15A may depict a view of user interface 1502A when tab 1515A is selected and FIG. 15B may depict a view of user interface 1502A when tab 1515B is selected. When tab 1515A is selected, a conversational display may be presented, where the conversational display may include messages from a user and corresponding responses. For instance, a user 1507 may provide a first message 1505A (e.g., a user query) to a virtual persona service via user interface 1502A. The virtual persona service may provide a first response 1510A to the first message 1505A from a first virtual persona 1512A and a second response 1510B to the first message 1505A from a second virtual persona 1512B. Additionally, the user 1507 may provide a second message 1505B (e.g., a second user query) to the virtual persona service via user interface 1502A. The virtual persona service may provide a third response 1510C to the second message 1505B from the first virtual persona 1512A and may provide a fourth response 1510D to the second message 1505B from a third virtual persona 1512C. When tab 1515B is selected, user interface 1502A may display an insights report. The insights report may provide a summary of responses from the virtual persona community.

### User Interface|Survey

Surveys may be used for quantitative analysis of audience opinions and behaviors. Virtual personas may be deployed to complete structured survey. The survey questions presented to the personas may cover a range of topics, with each persona responding based on its defined attributes, such as age, gender, and cultural background. This simulation may provide researchers with a dataset that reflects potential audience responses under controlled conditions, offering valuable insights into targeted demographic segments.

For the analysis of survey data, S240 may implement a more advanced natural language processing (NLP) analysis layer. This layer may perform multiple analytical tasks, including sentiment analysis, topic extraction, emotion detection, and keyword extraction, enabling a multidimensional understanding of persona responses. Following this initial analysis, a summarization and relevance-ranking task may be executed using a large language model (LLM). The LLM may synthesize the findings, highlight significant trends, and rank insights by relevance to ensure clarity and actionable interpretation of the data.

The results generated from this analysis may offer a view of majority opinions as well as emerging trends within specific demographic subgroups. This synthetic survey approach may enable users to efficiently gather and interpret large volumes of demographic-specific data, providing a robust foundation for decision-making. By combining virtual personas with sophisticated analysis techniques, S240 may enhance the scalability and precision of traditional survey methodologies.

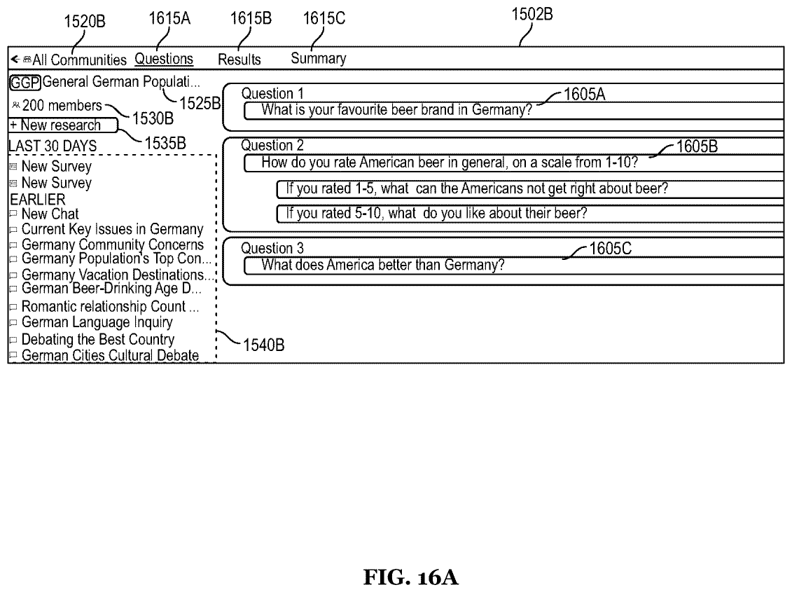

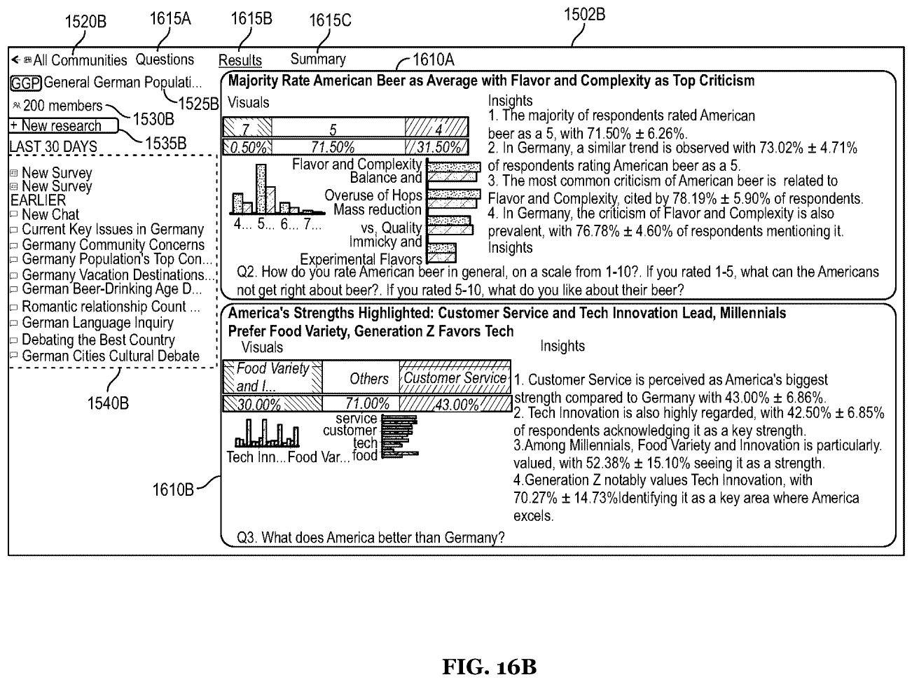

In a non-limiting example, FIGS. 16A and 16B may represent an example of an interactive user interface 1502B configured to simulate a survey using a virtual persona community. FIG. 16A may depict a first view of user interface 1502B and FIG. 16B may depict a second view of interactive user interface 1502B. In some examples, user interfaces 1502A and 1502B may be a same user interface, but user interface 1502A may represent a view of the user interface during a group discussion simulation and user interface 1502B may represent a view of the user interface during a survey simulation. In some examples, user interfaces 1502A and 1502B may be an example of a user interface 110 as described with reference to FIG. 1.

User interface 1502B may include a first user interface display element 1525B indicating a name of a virtual persona community and a second user interface display element 1530B indicating a number of virtual personas within the virtual persona community. Additionally, user interface 1502B may include a first user interface control element 1535B that may initiate a new survey simulation or a new group discussion simulation and a group 1540B of user interface control elements that may enable a user to interact and view other previously simulated surveys or group discussions. Additionally, user interface 1520B may include a second user interface control element 1520B that may enable a user to interact and view other previously generated virtual persona communities.

As depicted in FIGS. 16A and 16B, user interface 1502B may include tabs 1615, 1615B, and 1615C. FIG. 16A may depict a view of user interface 1502B when tab 1615A is selected and FIG. 16B may depict a view of user interface 1502B when tab 1615B is selected. When tab 1615A is selected, a group of survey questions (e.g., user queries) may be displayed. For instance, as depicted in FIG. 16A, survey questions 1605A, 1605B, and 1605C may be displayed, where one or more of survey questions 1605A, 1605B, and 1605C (e.g., survey question 1605B) may have sub-questions. When tab 1615B is selected, a group of insights associated with the survey questions may be depicted. For instance, when tab 1615B is selected, a first user interface display element 1610A displaying first insights may be displayed and a second user interface display element 1610B displaying second insights may be displayed. Each of first user interface display elements 1610A and second user interface display elements 1610B may display a title for the insights, one or more visuals (e.g., graphs, tables) associated with the insights, and textual descriptions of the insights. The insights may be generated based on the virtual persona community. Selecting tab 1615C may bring up a view of user interface 1502B that displays a summary of the results displayed when tab 1615B is selected.

### Response Generation Pipeline Optimization

Optimizing the performance of artificial personas in chat and survey contexts may involve evaluating various prompting techniques and selecting models that are most effective for role-playing tasks. The choice of prompting techniques, such as chain-of-thought (CoT) prompting or structured prompt styles, and the selection of culturally and demographically aligned models, may be key factors in achieving optimal responses. Certain models may exhibit stronger alignment with specific cultural nuances or demographic attributes, enhancing their effectiveness in particular role-playing scenarios. These factors may directly influence the quality and relevance of responses generated by artificial personas.

On the implementation level, the performance of role-playing tasks may heavily depend on the choice of prompting techniques. CoT prompting, for example, may improve the consistency and depth of persona responses, particularly in scenarios involving complex reasoning or nuanced perspectives. In focus group simulations, CoT prompting may enable personas to articulate detailed opinions and reflect shared values within a group setting. Conversely, direct instruction-based prompting may be more effective for concise and straightforward responses, such as those required in survey contexts. Iterative testing and refinement of these prompting techniques across various scenarios may tailor persona behavior to align with their demographic and psychographic profiles.

The selection of models may also play a significant role in optimizing persona performance. Some models may inherently demonstrate greater proficiency in role-playing, capturing personas' attributes with higher fidelity. Additionally, models fine-tuned with region-specific data may produce responses that are more contextually and culturally accurate. For instance, personas from the Middle East or South Asia may exhibit enhanced authenticity when generated using models trained on data from these regions. Selecting culturally aligned models may be essential for maintaining the realism of personas' responses and ensuring that the insights derived from their interactions reflect real-world cultural sensitivities.

### 3.00 Computer-Implemented Method and Computer Program Product

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

Although omitted for conciseness, the preferred embodiments include every combination and permutation of the implementations of the systems and methods described herein.

As a person skilled in the art will recognize from the previous detailed description and from the figures and claims, modifications and changes can be made to the preferred embodiments of the invention without departing from the scope of this invention defined in the following claims.

We claim:

1. A computer-implemented method, comprising:
at a virtual persona service:
identifying, by one or more processors, a respective set of permitted values or a respective distribution of values for each community persona variable of a set of community persona variables;
constructing, by the one or more processors, a virtual community persona template that indicates the respective set of permitted values or the respective distribution of values for each community persona variable of the set of community persona variables;
generating, by the one or more processors, a virtual persona community based at least in part on the virtual community persona template, wherein the generating comprises:
providing, by the one or more processors, the virtual community persona template and a set of persona-generating prompts to one or more language models, wherein each persona-generating prompt of the set of persona-generating prompts comprises a set of instructions informing the one or more language learning models to select variable values for a respective subset of the set of community persona variables;
obtaining, by the one or more processors, one or more batches of virtual personas from the one or more language learning models based at least in part on the provided virtual community persona template and the set of persona-generating prompts, wherein each batch of the one or more batches comprises a plurality of distinct sets of community persona variables and associated variable values, each distinct set of the plurality of distinct sets mapping to a respective virtual persona;
aggregating, by the one or more processors, the one or more batches of virtual personas to form the virtual persona community;
receiving, by the one or more processors, a user query and an indication of a virtual persona of the virtual persona community via an interactive user interface;
constructing, by the one or more processors, a persona-describing prompt based at least in part on the respective distinct set of community variables and associated variable values corresponding to the indicated virtual persona;
providing, by the one or more processors and to the one or more language learning models, the user query and the persona-describing prompt; and
outputting, by the one or more processors and from the one or more language learning models, a response to the user query via the interactive user interface based at least in part on the provided user query and the persona-describing prompt.

2. The computer-implemented method according to claim 1, further comprising:
at the virtual persona service:
applying, by the one or more processors and for each virtual persona generated by the one or more language learning models for a batch of the one or more batches, a variable value consistency assessment to identify a subset of the virtual personas that each have one or more community persona variables associated with an attribute inconsistency, a logical contradiction, or a statistical anomaly; and
updating, by the one or more processors, each virtual persona of the subset of the virtual personas, wherein the updating comprises generating updated values for the respective one or more community persona variables associated with the attribute inconsistency, the logical contradiction, or the statistical anomaly for each of the subset of the virtual personas.

3. The computer-implemented method according to claim 2, further comprising:
at the virtual persona service:
applying, by the one or more processors and for each of the updated virtual personas, a second variable value consistency assessment to identify a subset of the additional virtual personas that each have one or more community persona variables associated with a logical contradiction;
discarding, by the one or more processors, the subset of the updated virtual personas associated with the logical contradiction from the batch.

4. The computer-implemented method according to claim 1, wherein identifying the respective set of permitted values or the respective distribution for each community persona variable of the set of community persona variables comprises:
at the virtual persona service:
extracting, by the one or more processors and from one or more digital artifacts, data that indicates the respective set of permitted values or the respective distribution of values for a first subset of the set of community persona variables;
generating, by the one or more processors and from the data, the respective set of permitted values or the respective distribution of values for the first subset of the set of community persona variables; and
generating, by the one or more processors and using the one or more language learning models, a respective set of permitted values or a respective distribution of values for each of a second subset of the set of community persona variables.

5. The computer-implemented method according to claim 4, wherein generating the respective set of permitted values or the respective distribution of values for each of the second subset of the set of community persona variables is based at least in part on identifying that the virtual persona service has failed to extract data corresponding to the second subset of the set of community persona variables from the one or more digital artifacts.

6. The computer-implemented method according to claim 1, wherein the one or more batches comprises a first batch and a second batch, the computer-implemented method further comprising:
at the virtual persona service:
determining, by the one or more processors and after obtaining the first batch, a difference between a first distribution of values associated with the first batch for a community persona variable and the distribution of values identified for the community persona variable; and
updating, by the one or more processors, a prompt of the set of prompts associated with the community persona variable based at least in part on the difference, wherein the second batch is obtained based at least in part on the updated prompt.

7. The computer-implemented method according to claim 6, wherein:
the one or more batches comprises a plurality of batches,
the plurality of batches comprises the first batch and the second batch and is obtained in an iterative sequence,
the first batch is obtained before the second batch in the iterative sequence, and the computer-implemented method further comprises:
at the virtual persona service:
(a) updating, by the one or more processors, the first distribution of values based at least in part on obtaining the second batch;
(b) determining, by the one or more processors and after obtaining the second batch, an updated difference between the updated first distribution of values and the distribution of values identified for the community persona variable;
(c) updating, by the one or more processors, the prompt of the set of prompts associated with the community persona variable based at least in part on the updated difference, wherein a subsequent batch in the sequence is obtained based at least in part on the updated prompt;
(d) repeating (a) through (c) for each batch of the plurality of batches subsequent to the second batch in an order defined by the iterative sequence, wherein (a) through (c) is repeated until a total quantity of samples associated with the obtained batches exceeds a threshold amount.

8. The computer-implemented method according to claim 1, further comprising:
at the virtual persona service:
splitting, by the one or more processors, a video asset into a sequence of video chunks;
extracting, by the one or more processors and from each video chunk of the sequence, video information comprising a respective audio transcript associated with the video chunk, an interpretation of one or more activities that occur within the video chunk, and a set of frames associated with the video chunk;
linking, by the one or more processors, one or more virtual personas of the virtual persona community with an identifier of the video asset; and
generating, by the one or more processors, the one or more responses based at least in part on the video information and the one or more virtual personas being linked with the identifier of the video asset.

9. The computer-implemented method according to claim 1, further comprising:
at the virtual persona service:
generating, by the one or more processors, a respective profile for each virtual persona of the virtual persona community, wherein the respective profile for each virtual persona comprises a comprises an identifier for the virtual persona and an indication of values for each community persona variable of the set of community persona variables;
generating, by the one or more processors, a profile for the virtual persona community, wherein the profile for the virtual persona community comprises an identifier for the virtual persona community and a list of virtual personas within the virtual persona community; and
providing, by the one or more processors, the respective profile for each virtual persona and the profile for the virtual persona community to a storage service.

10. The computer-implemented method according to claim 9, further comprising:
at the virtual persona service:
synchronizing, by the one or more processors, the respective profile for each virtual persona with a database distinct from the storage service.

11. The computer-implemented method according to claim 10, further comprising:
at the virtual persona service:
generating, by the one or more processors and after performing the synchronizing, reinforcement learning metadata for each of the virtual personas within the virtual persona community; and
tuning, by the one or more processors, the one or more language learning models based at least in part on the reinforcement learning metadata.

12. The computer-implemented method according to claim 1, further comprising:
at the virtual persona service:
calling an inference endpoint to generate a respective profile image for each of the virtual personas of the virtual persona community and a profile image for the virtual persona community;
receiving, from the interference endpoint, the respective profile image for each of the virtual personas and the profile image for the virtual persona community;
storing, by the one or more processors, the respective profile image for each of the virtual personas and the profile image for the virtual persona community at a storage service; and
outputting, by the one or more processors and via the user interface, the respective profile image for each of the virtual personas of the virtual persona community and the profile image for the virtual persona community.

13. The computer-implemented method according to claim 1, wherein:
identifying, by the one or more processors, the respective set of permitted values or the respective distribution of values for each community persona variable of the set of community persona variables comprises:
at the virtual persona service:
receiving, by the one or more processors and via the user interface, an indication of the respective set of permitted values or the respective distribution of values for each community persona variable of the set of community persona variables.

14. The computer-implemented method according to claim 1, wherein outputting the response comprises:
outputting an opinion that is directly based at least in part on the variable values associated with the virtual persona, thereby mitigating bias associated with one or more responses provided by the virtual persona community.

15. The computer-implemented method according to claim 1, wherein each persona-generating prompt of the set of persona-generating prompts is a multi-part prompt that comprises a first part informing a community persona variable selection operation of the language learning model and the second part informing a variable value selection operation of the language learning model, the communication persona variable selection operation and the variable value selection operation for selecting the community persona variables and associated variable values, respectively, of the distinct sets.

16. The computer-implemented method according to claim 1, wherein the variable values associated with the plurality of distinct sets of community persona variables are obtained based at least in part on sampling the respective set of permitted values or the respective distribution of values associated with the community persona variables of the plurality of distinct sets.

17. A computer-program product comprising a non-transitory machine-readable storage medium storing computer instructions that, when executed by one or more processors, perform operations comprising:
at a virtual persona service:
identifying, by the one or more processors, a respective set of permitted values or a respective distribution of values for each community persona variable of a set of community persona variables;
constructing, by the one or more processors, a virtual community persona template that indicates the respective set of permitted values or the respective distribution of values for each community persona variable of the set of community persona variables;
generating, by the one or more processors, a virtual persona community based at least in part on the virtual community persona template, wherein the generating comprises:
providing, by the one or more processors, the virtual community persona template and a set of persona-generating prompts to one or more language models, wherein each persona-generating prompt of the set of persona-generating prompts comprises a set of instructions informing the one or more language learning models to select variable values for a respective subset of the set of community persona variables;
obtaining, by the one or more processors, one or more batches of virtual personas from the one or more language learning models based at least in part on the provided virtual community persona template and the set of persona-generating prompts, wherein each batch of the one or more batches comprises a plurality of distinct sets of community persona variables and associated variable values, each distinct set of the plurality of distinct sets mapping to a respective virtual persona;
aggregating, by the one or more processors, the one or more batches of virtual personas to form the virtual persona community;
receiving, by the one or more processors, a user query and an indication of a virtual persona of the virtual persona community via an interactive user interface;
constructing, by the one or more processors, a persona-describing prompt based at least in part on the respective distinct set of community variables and associated variable values corresponding to the indicated virtual persona;
providing, by the one or more processors and to the one or more language learning models, the user query and the persona-describing prompt; and
outputting, by the one or more processors and from the one or more language learning models, a response to the user query via the interactive user interface based at least in part on the provided user query and the persona-describing prompt.

18. The computer-program product according to claim 17, wherein the operations further comprise:
at the virtual persona service:
applying, by the one or more processors and for each virtual persona generated by the one or more language learning models for a batch of the one or more batches, a variable value consistency assessment to identify a subset of the virtual personas that each have one or more community persona variables associated with an attribute inconsistency, a logical contradiction, or a statistical anomaly; and
updating, by the one or more processors, each virtual persona of the subset of the virtual personas, wherein the updating comprises generating updated values for the respective one or more community persona variables associated with the attribute inconsistency, the logical contradiction, or the statistical anomaly for each of the subset of the virtual personas.

19. The computer-program product according to claim 18, wherein the operations further comprise:
applying, by the one or more processors and for each of the updated virtual personas, a second variable value consistency assessment to identify a subset of the additional virtual personas that each have one or more community persona variables associated with a logical contradiction;
discarding, by the one or more processors, the subset of the updated virtual personas associated with the logical contradiction from the batch.

20. A computer-implemented system, comprising:
one or more processors;
a memory; and
a computer-readable medium operably coupled to the one or more processors, the computer-readable medium having computer-readable instructions stored thereon that, when executed by the one or more processors, cause a computing device to perform operations comprising:
at a virtual persona service:
identifying, by the one or more processors, a respective set of permitted values or a respective distribution of values for each community persona variable of a set of community persona variables;
constructing, by the one or more processors, a virtual community persona template that indicates the respective set of permitted values or the respective distribution of values for each community persona variable of the set of community persona variables;
generating, by the one or more processors, a virtual persona community based at least in part on the virtual community persona template, wherein the generating comprises:
providing, by the one or more processors, the virtual community persona template and a set of persona-generating prompts to one or more language models, wherein each persona-generating prompt of the set of persona-generating prompts comprises a set of instructions informing the one or more language learning models to select variable values for a respective subset of the set of community persona variables;
obtaining, by the one or more processors, one or more batches of virtual personas from the one or more language learning models based at least in part on the provided virtual community persona template and the set of persona-generating prompts, wherein each batch of the one or more batches comprises a plurality of distinct sets of community persona variables and associated variable values, each distinct set of the plurality of distinct sets mapping to a respective virtual persona;
aggregating, by the one or more processors, the one or more batches of virtual personas to form the virtual persona community;
receiving, by the one or more processors, a user query and an indication of a virtual persona of the virtual persona community via an interactive user interface;
constructing, by the one or more processors, a persona-describing prompt based at least in part on the respective distinct set of community variables and associated variable values corresponding to the indicated virtual persona;
providing, by the one or more processors and to the one or more language learning models, the user query and the persona-describing prompt; and
outputting, by the one or more processors and from the one or more language learning models, a response to the user query via the interactive user interface based at least in part on the provided user query and the persona-describing prompt.
